(19) United States
(12) Patent Application Publication
(10) Pub. No.: US 2013/0275117 A1
(43) Pub. Date: Oct. 17, 2013

(54) Generalized Phonetic Transliteration Engine

(71) Applicant: Morgan H. Winer, Sunnyvale, CA (US)

(72) Inventor: Morgan H. Winer, Sunnyvale, CA (US)

(21) Appl. No.: 13/469,047

(22) Filed: May 10, 2012

Related U.S. Application Data
(60) Provisional application No. 61/623,039, filed on Apr. 11, 2012.

(51) Int. Cl. G06F 17/28

(52) U.S. Cl. 704/3

(57) ABSTRACT

Methods and systems for transliterating characters from an input alphabet to an output alphabet are described. An input character of an input alphabet is received from a user. The input character is located on a phonetic map. The phonetic map includes each character of the input alphabet and each character of an output alphabet. In the phonetic map, respective characters of the input alphabet are located according to their phonetic similarity. Respective characters of the output alphabet are located within the phonetic map according to their phonetic similarity. And characters of the input alphabet and the output alphabet that are phonetically similar are located nearby one another on the phonetic map. One or more output characters that are near to the input character on the phonetic map are identified. At least one of the one or more output characters are provided for display to the user.

### RELATED APPLICATION

This application claims priority to U.S. Provisional Application Ser. No. 61/623,039, filed Apr. 11, 2012, which is incorporated herein by reference in its entirety.

### TECHNICAL FIELD

The present disclosure relates generally to systems and methods for transliterating characters and words from one alphabet to another.

### BACKGROUND

There are thousands of different languages in the world, and there are many different alphabets that are used to represent those languages. Modern electronic devices, such as computers, cell phones, and the like, generally have one type of keyboard for uses to input text into the devices. For example, a Greek keyboard may be provided for entering text in the Greek language, and a Latin keyboard may be provided for entering text in the English language. However, sometimes it is more convenient for a user to input text using an input alphabet different from the desired output alphabet, such as when a device only has a Latin keyboard and the user wants to type in the Greek language.

Central to the concept of transliteration is that the notion of a language (i.e., a group of words) is different from the notion of an alphabet (i.e., a group of characters). While a given language may be associated with a particular alphabet, it is also possible to represent words in a given language with more than one alphabet. For example, words in the Greek language may be represented in the Greek alphabet, but they may also be phonetically represented using a Latin alphabet. Thus, it is possible to phonetically represent words in one language using a different alphabet—one that is typically associated with a different language entirely. It is therefore beneficial to provide a transliteration engine where words (or characters) may be input in a first alphabet, and be output in a second alphabet.

### SUMMARY

Accordingly, there is a need for electronic devices with faster, more flexible, and more robust methods for transliterating words and characters from a first alphabet to a second alphabet. Such methods and interfaces may complement or replace conventional methods for transliterating words and characters from a first alphabet to a second alphabet. Other ways of transliterating characters, using only character tables where input characters are correlated to output characters in a one-to-one or one-to-many configuration, cannot account for the inevitable variations in human speech and phonetic perception because they rely on discrete matches between characters. The transliteration engine disclosed herein leverages phonetic maps where each character of the input alphabet and each character of an output alphabet are mapped according to their phonetic similarity. This transliteration engine is more flexible and provides better, more robust transliteration results to users.

In accordance with some embodiments, a method is performed at an electronic device with a processor and memory. The method includes receiving, from a user, an input character of an input alphabet. The method also includes locating the input character on a phonetic map. The phonetic map includes each character of the input alphabet and each character of an output alphabet. In the phonetic map, respective characters of the input alphabet are located within the phonetic map according to their phonetic similarity. Also, respective characters of the output alphabet are located within the phonetic map according to their phonetic similarity. Finally, characters of the input alphabet and the output alphabet that are phonetically similar are located nearby one another on the phonetic map. The method also includes identifying one or more output characters that are near to the input character on the phonetic map, and providing at least one of the one or more output characters for display to the user.

In some embodiments, the method includes receiving a plurality of additional input characters and identifying a plurality of intermediate output characters, wherein each respective intermediate output character is near to a respective one of the plurality of additional input characters on the phonetic map. In some embodiments, the method further includes identifying a single character of the output alphabet that is associated with a phonetic sound similar to a phonetic sound associated with the plurality of intermediate output characters when the plurality of intermediate output characters are phonetically combined; and providing the single character of the output alphabet for display to the user. In some embodiments, the phonetic map includes at least one complex character comprising the plurality of additional input characters, and the additional output character is located near the complex character on the phonetic map.

In some embodiments, the method includes receiving an additional input character, and identifying a plurality of additional output characters of the output alphabet that, when phonetically combined, are associated with a phonetic sound similar to a phonetic sound associated with the additional input character. In some embodiments, the method further includes providing the plurality of additional output characters to the user.

In some embodiments, the method includes, prior to receiving the input character, including creating a first map of the input alphabet, wherein the respective characters of the input alphabet are mapped such that the distance between two respective input characters is inversely proportional to the similarity between the two characters' respective phonetic sounds. In some embodiments, the method further includes, prior to receiving the input character, creating a second map of the output alphabet, wherein the respective characters of the output alphabet are mapped such that the distance between two respective output characters is inversely proportional to the similarity between the two output characters' respective phonetic sounds.

In accordance with some embodiments, an electronic device including one or more processors, memory, and one or more programs stored in the memory and configured to be executed by the one or more processors include instructions for performing the operations of any of the methods described above. In accordance with some embodiments, a non-transitory computer readable storage medium has stored therein instructions which, when executed by an electronic device, cause the device to perform the operations of any of the methods described above.

In accordance with some embodiments, an electronic device includes an input receiving unit configured to receive, from a user, an input character of an input alphabet. The electronic device also includes a processing unit coupled to the input receiving unit. The processing unit is configured to: locate the input character on a phonetic map, wherein the phonetic map includes each character of the input alphabet and each character of an output alphabet. With respect to the phonetic maps, respective characters of the input alphabet are located within the phonetic map according to their phonetic similarity; respective characters of the output alphabet are located within the phonetic map according to their phonetic similarity; and characters of the input alphabet and the output alphabet that are phonetically similar are located nearby one another on the phonetic map. The processing unit is also configured to identify one or more output characters that are near to the input character on the phonetic map, and provide at least one of the one or more output characters for display to the user.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 is a block diagram illustrating a computer environment in which a transliteration engine may be used, in accordance with some embodiments.

FIG. 2 is a block diagram illustrating a computer system in accordance with some embodiments.

FIG. 3 illustrates a phonetic map of a portion of an alphabet in accordance with some embodiments.

FIG. 4 illustrates a phonetic map of a portion of another alphabet in accordance with some embodiments.

FIGS. 5-7 illustrate a phonetic map of a portion of two alphabets in accordance with some embodiments.

FIG. 8 illustrates a character table with characters of two alphabets in accordance with some embodiments.

FIG. 9 illustrates a character table with characters of one alphabet in accordance with some embodiments.

FIG. 10 illustrates a word selection routine in accordance with some embodiments.

FIGS. 11-14 are flow diagrams illustrating methods for transliterating characters from an input alphabet to an output alphabet in accordance with some embodiments.

FIGS. 15-16 are flow diagrams illustrating methods for identifying an output alphabet in accordance with some embodiments.

FIG. 17 is a flow diagram illustrating a method 1700 for suggesting words to a user in accordance with some embodiments.

FIG. 18 is functional block diagram of an electronic device in accordance with some embodiments.

### DESCRIPTION OF EMBODIMENTS

As noted above, transliteration systems and methods enable the input of text into devices where keyboards for a certain alphabet are not available or not preferred. In some cases, some characters in one alphabet are equivalent to some characters in another alphabet. Transliteration between equivalent characters can be very straightforward. But in many cases, the characters in different alphabets are not equivalent. Indeed, respective characters in different alphabets may represent different phonemes altogether. For example, a first alphabet may lack a character that represents a particular phoneme in another alphabet. For example, the Latin alphabet lacks a character that corresponds to the phoneme associated with the Greek “θ” (a /th/ sound). Accordingly, a user would be required to input “th” on a Latin keyboard when they intend to represent the Greek “θ.” In this example, though, the Latin “th” is a very close approximation of the Greek “θ,” and most, if not all, users would use those Latin characters to represent the sound associated with “θ.”

Other character transliterations are more difficult, however, because different users may use different characters in the input alphabet to represent a phoneme in the output alphabet. For example, the Korean “ [symbol] ” corresponds to a vowel sound that may be described as somewhere between the Latin “e,” “o,” and “u,” (or some combination of these sounds) and may be represented by one user as a Latin “eo,” by another user as a Latin “uh,” and by another user as a Latin “er.” Accordingly, a transliteration system should be capable of identifying the correct output character despite the various different input characters that may be used to represent that output character.

As described in detail below, a transliteration engine in accordance with the inventions described herein uses multi-dimensional phonetic maps to convert characters from an input alphabet to an output alphabet. In some embodiments, phonetic maps include each character (or a subset of the characters) of a given alphabet, where the characters are located on the map according to their respective phonetic sounds. Specifically, the respective characters are located on the map according to their phonetic similarity: characters associated with similar phonetic sounds are located closer together, and characters associated with dissimilar phonetic sounds are located further apart. Moreover, the phonetic maps for use with a transliteration engine all use a common phonetic space, such that characters in different alphabets that have similar sounds are located in similar places in their respective maps. The transliteration engine as described below uses these phonetic maps to determine the output characters that are most likely to correspond to the phonetic sound represented by the input characters.

Because the phonetic maps include all or substantially all of the characters of respective alphabets, the maps do not rely solely on discrete correlations of input characters to output characters. Transliterations that use only these discrete correlations, such as those using tables that correlate input characters to output characters, often produce incorrect transliteration results. In the phonetic maps, however, each character is mapped with respect to all other characters in that alphabet. This allows for a flexible approach to determining what output character (or characters) should be selected in response to a given input character (or characters), because the phonetic maps are not limited to predetermined correlations of input characters and output characters. The phonetic maps, and how they are generated and used, are described in greater detail below.

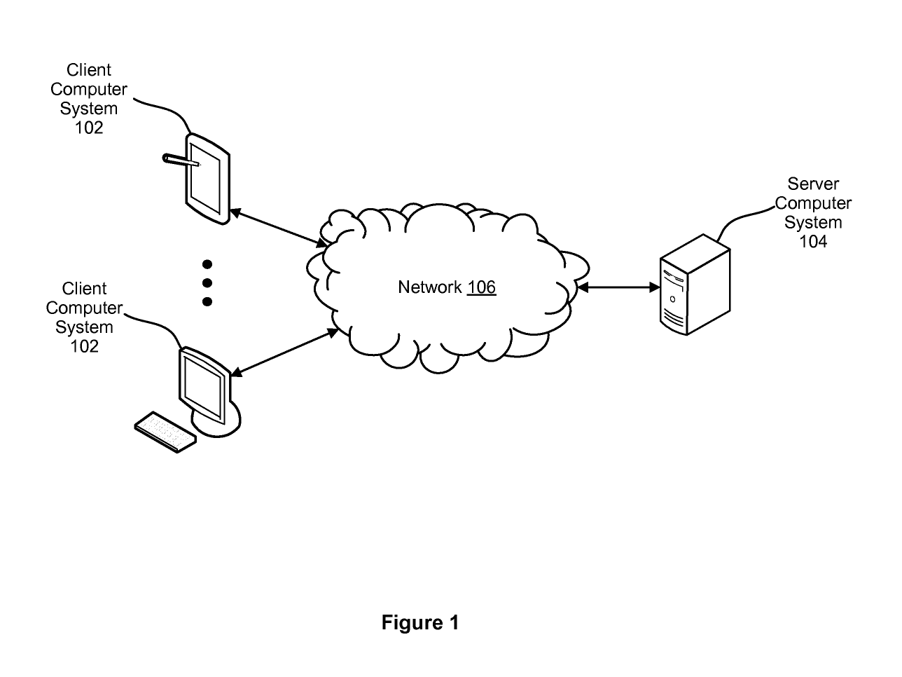

FIG. 1 illustrates a computer environment in which a transliteration engine may be used. The computer environment includes client computer system(s) 102, and server computer system(s) 104 (sometimes referred to as client computers and server computers, respectively). Client computer systems 102 include, but are not limited to, laptop computers, desktop computers, tablet computers, handheld and/or portable computers, PDAs, cellular phones, smartphones, video game systems, digital audio players, remote controls, watches, televisions, and the like.

In some embodiments, client computers 102 include transliteration engines so that a user may enter text in a first alphabet (i.e., an input alphabet), and have the text converted into a second alphabet (i.e., an output alphabet) for display and/or storage. In some embodiments, client computers 102 include the necessary data and programs to perform the transliteration locally, and server computer systems 104 are not required. In some embodiments, client computers 102 communicate with one or more server computer systems 104 via network 106. In some embodiments, server computer systems 104 are configured to provide services related to transliteration. For example, server computer systems 104 may receive text from a client computer 102 in an input alphabet, transliterate the text into an output alphabet, and send the transliterated text back to client computer 102. Alternatively, the server computer systems 104 may provide data (e.g., phonetic maps) to a client-based transliterating engine, and the actual transliteration is performed at the client computer 102.

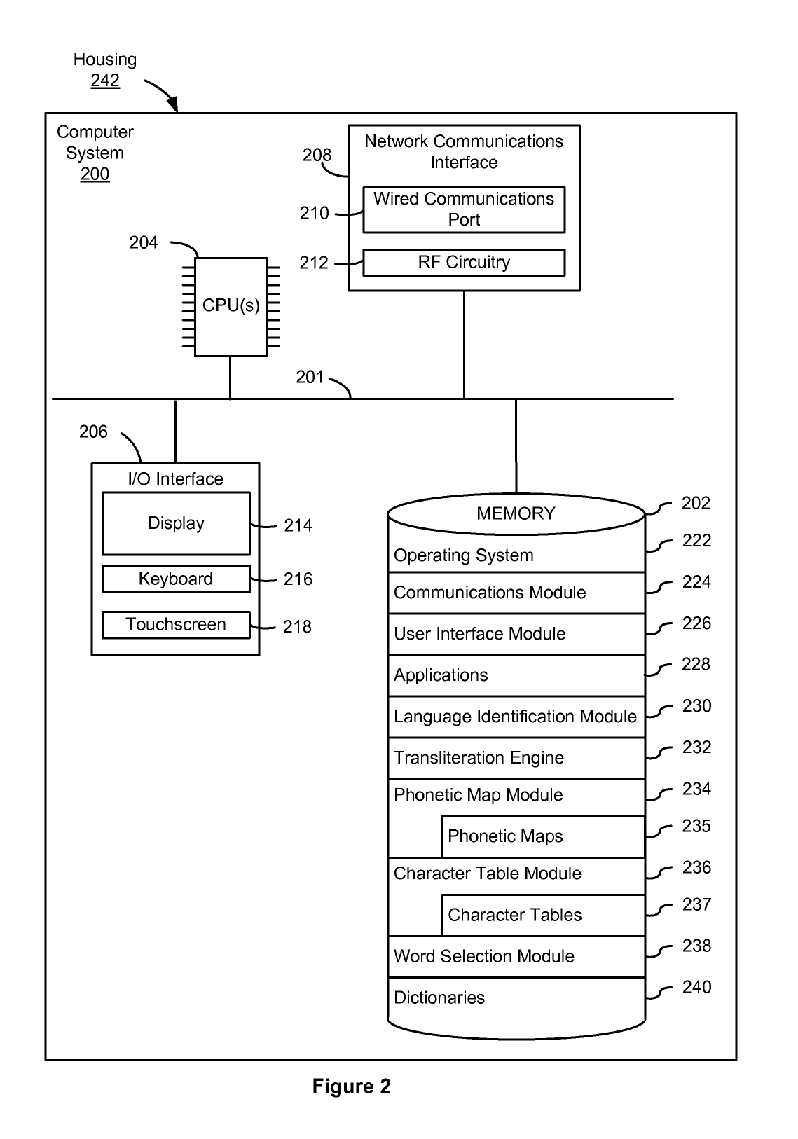

FIG. 2 is a block diagram depicting a computer system 200 in accordance with some embodiments. In some embodiments, the computer system 200 represents a client computer system 102, a server computer system 104, or both. In some embodiments, the components described as being part of the computer system 200 are distributed across multiple client computers 102, server computers 104, or any combination of client and server computers.

Moreover, computer system 200 is only one example of a suitable computer system, and some embodiments will have fewer or more components, may combine two or more components, or may have a different configuration or arrangement of the components than those shown in FIG. 2. The various components shown in FIG. 2 may be implemented in hardware, software, or a combination of hardware and software, including one or more signal processing and/or application specific integrated circuits.

Returning to FIG. 2, in some embodiments, the computer system 200 includes memory 202 (which may include one or more computer readable storage mediums), one or more processing units (CPU's) 204, an input/output (I/O) interface 206, and a network communications interface 208. These components may communicate over one or more communication buses or signal lines 201. Communication buses or signal lines 201 may include circuitry (sometimes called a chipset) that interconnects and controls communications between system components.

Network communications interface 208 includes wired communications port 210 and/or RF (radio frequency) circuitry 212. Wired communications port 210 receives and sends communication signals via one or more wired interfaces. Wired communications port 210 (e.g., Ethernet, Universal Serial Bus (USB), FIREWIRE, etc.) is adapted for coupling directly to other devices or indirectly over a network (e.g., the Internet, wireless LAN, etc.). In some embodiments, wired communications port 210 is a multi-pin (e.g., 30-pin) connector that is the same as, or similar to and/or compatible with the 30-pin connector used on Applicant's IPHONE®, IPOD TOUCH®, and IPAD® devices. In some embodiments, the wired communications port is a modular port, such as an RJ type receptacle.

RF circuitry 212 receives and sends RF signals, also called electromagnetic signals. RF circuitry 212 converts electrical signals to/from electromagnetic signals and communicates with communications networks and other communications devices via the electromagnetic signals. RF circuitry 212 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. Network communications interface 208 (in conjunction with wired communications port 210 and RF circuitry 212) enables communication with networks, such as the Internet, also referred to as the World Wide Web (WWW), an intranet and/or a wireless network, such as a cellular telephone network, a wireless local area network (LAN) and/or a metropolitan area network (MAN), and other devices. Wireless communication may use any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol.

I/O interface 206 couples input/output devices of the computer system 200, such as display 214, keyboard 216, and touch screen 218, to the user interface module 226. I/O interface 206 may also include other input/output components, such as physical buttons (e.g., push buttons, rocker buttons, etc.), dials, slider switches, joysticks, click wheels, and so forth.

Display 214 displays visual output to the user. The visual output may include graphics, text, icons, video, and any combination thereof (collectively termed “graphics”). In some embodiments, some or all of the visual output may correspond to user-interface objects. In some embodiments, the display 214 uses LCD (liquid crystal display) technology, LPD (light emitting polymer display) technology, LED (light emitting diode) technology, OLED technology, or any other suitable technology or output device.

Keyboard 216 allows a user to interact with computer system 200 by inputting characters and controlling operational aspects of computer system 200. Keyboards for various different alphabets may be used in conjunction with computer system 200. Computer system 200, through I/O interface 206 and user interface module 224, may be configured to process input from keyboard 216 in accordance with the alphabet associated with keyboard 216. For example, if a Latin keyboard 216 is used, computer system 200 will recognize that input from the keyboard corresponds to Latin characters. In some embodiments, the alphabet associated with keyboard 216 is automatically detected by computer system 200. For example, a keyboard may communicate with computer system 200 in order to identify the alphabet with which it is associated.

In some embodiments, keyboard 216 is a physical keyboard with a fixed key set. In some embodiments, the keyboard 216 is a touchscreen-based, or “virtual” keyboard, such that different key sets (corresponding to different alphabets, character layouts, etc) may be displayed on display 214, and input corresponding to selection of individual keys may be sensed by touchscreen 218.

Touchscreen 218 has a touch-sensitive surface, sensor or set of sensors that accepts input from the user based on haptic and/or tactile contact. Touchscreen 218 (along with any associated modules and/or sets of instructions in memory 202) detects contact (and any movement or breaking of the contact) on touchscreen 218 and converts the detected contact into interaction with user-interface objects (e.g., one or more soft keys, icons, web pages or images) that are displayed on display 214.

Touchscreen 218 detects contact and any movement or breaking thereof using any of a plurality of suitable touch sensing technologies, including but not limited to capacitive, resistive, infrared, and surface acoustic wave technologies, as well as other proximity sensor arrays or other elements for determining one or more points of contact with touchscreen 218. In an exemplary embodiment, projected mutual capacitance sensing technology is used, such as that found in Applicant's IPHONE®, IPOD TOUCH®, and IPAD® devices.

Memory 202 may include high-speed random access memory and may also include non-volatile and/or non-transitory computer readable storage media, such as one or more magnetic disk storage devices, flash memory devices, or other non-volatile solid-state memory devices. In some embodiments, memory 202, or the non-volatile and/or non-transitory computer readable storage media of memory 202, stores the following programs, modules, and data structures, or a subset thereof: operating system 222, communications module 224, user interface module 226, applications 228, language identification module 230, transliteration engine 232, phonetic map module 234, character table module 236, word selection module 238, and dictionaries 240.

Operating system 222 (e.g., DARWIN, RTXC, LINUX, UNIX, OS X, WINDOWS, or an embedded operating system such as VXWORKS) includes various software components and/or drivers for controlling and managing general system tasks (e.g., memory management, storage device control, power management, etc.) and facilitates communication between various hardware and software components.

Communications module 224 facilitates communication with other devices over network communications interface 208 and also includes various software components for handling data received by RF circuitry 212 and/or wired communications port 210.

User interface module 226 receives commands and/or inputs from a user via I/O interface (e.g., from keyboard 216 and/or touchscreen 218), and generates user interface objects on display 214. In some embodiments, user interface module 226 provides virtual keyboards for entering text via touchscreen 218.

Applications 228 may include programs and/or modules that are configured to be executed by the computer system 200. In some embodiments, the applications include the following modules (or sets of instructions), or a subset or superset thereof:
contacts module (sometimes called an address book or contact list);
telephone module;
video conferencing module;
e-mail client module;
instant messaging (IM) module;
workout support module;
camera module for still and/or video images;
image management module;
browser module;
calendar module;
widget modules, which may include one or more of: weather widget, stocks widget, calculator widget, alarm clock widget, dictionary widget, and other widgets obtained by the user, as well as user-created widgets;
widget creator module for making user-created widgets;
search module;
media player module, which may be made up of a video player module and a music player module;
notes module;
map module; and/or
online video module.
Examples of other applications 228 that may be stored in memory 202 include word processing applications, image editing applications, drawing applications, presentation applications, JAVA-enabled applications, encryption, digital rights management, voice recognition, and voice replication applications.

Language identification module 230 identifies the target language that a user intends to use. In some embodiments, the language identification module 230 also identifies input and output alphabets. In some embodiments, the target language, the input alphabet, and the output alphabet are identified by the computer system 200 to ensure fast, efficient, and correct transliterations, as this information will help define the phonetic maps and dictionaries that are used by the transliteration engine, as described below. In some embodiments, the target language and the input and output alphabets are manually selected by a user. In some embodiments, the target language and the input and output alphabets are determined automatically.

In some embodiments, a user selects the intended language as well as the intended input and output alphabets. For example, such selections may be made at the device level or the application level. In some embodiments, a device may have a language setting that determines the default language for the device and/or applications running on that device. That language is then presumed to be the input language. In some embodiments, applications or modules on the device allow a user to select a language to be used for a particular application or text input session (such as when the user is composing a text message). The user may also select a particular input alphabet (e.g., Latin), and a particular output alphabet (e.g., Greek).

In some embodiments, language identification module 230 infers an intended input alphabet (i.e., automatically, without user input intended to specify an alphabet selection), such as by determining what virtual keyboard has been selected by the user or is active on display 214, or what hard keyboard is provided or attached to the computer system 200. In some embodiments, language identification module 230 infers an intended output alphabet based on the intended language. For example, when language identification module 230 identifies Greek as the intended language, language identification module 230 also identifies the Greek alphabet as the intended output alphabet. This identification may occur automatically as the user starts typing, i.e., without the user identifying the output language or alphabet.

In some embodiments, computer system 200 automatically determines the intended language based on user input. For example, as described in detail below, a user may begin to input text before computer system 200 has determined or identified the user's intended language. Computer system 200 may transliterate the input text into words of various different alphabets until a language is identified that includes words corresponding to the transliterated text. If a word corresponding to the transliterated text is found in a particular language, language identification module 230 may identify that particular language as the intended language. If the word is found in multiple languages, language identification module 230 may repeat the process with subsequent words until the intended language is determined. For example, if a user types the word “thelo,” using a Latin keyboard, computer system 200 may transliterate that word into several different languages (e.g., Greek, Russian, Chinese, etc.), and search dictionaries of those languages to identify whether the transliterated word is found in that language. In this case, the Greek transliteration, “θ\acute{ε}λω,” would be found in the Greek dictionary, indicating that the intended language is Greek.

Transliteration engine 232 performs the transliteration of a user's input from an input alphabet to an output alphabet. In some embodiments, transliteration engine 232 uses one or more phonetic maps 235 and/or character tables 237 to determine what output characters most likely correspond to respective input characters received from the user. In some embodiments, transliteration engine 232, in conjunction with the word selection module 238, then determines what words (in the identified output alphabet) the user intended to represent with the chosen characters from the input alphabet. Transliteration engine 232 may then pass the transliterated words to user interface module 226, or another component or module of computer system 200, for output to the user (e.g., shown on display 214).

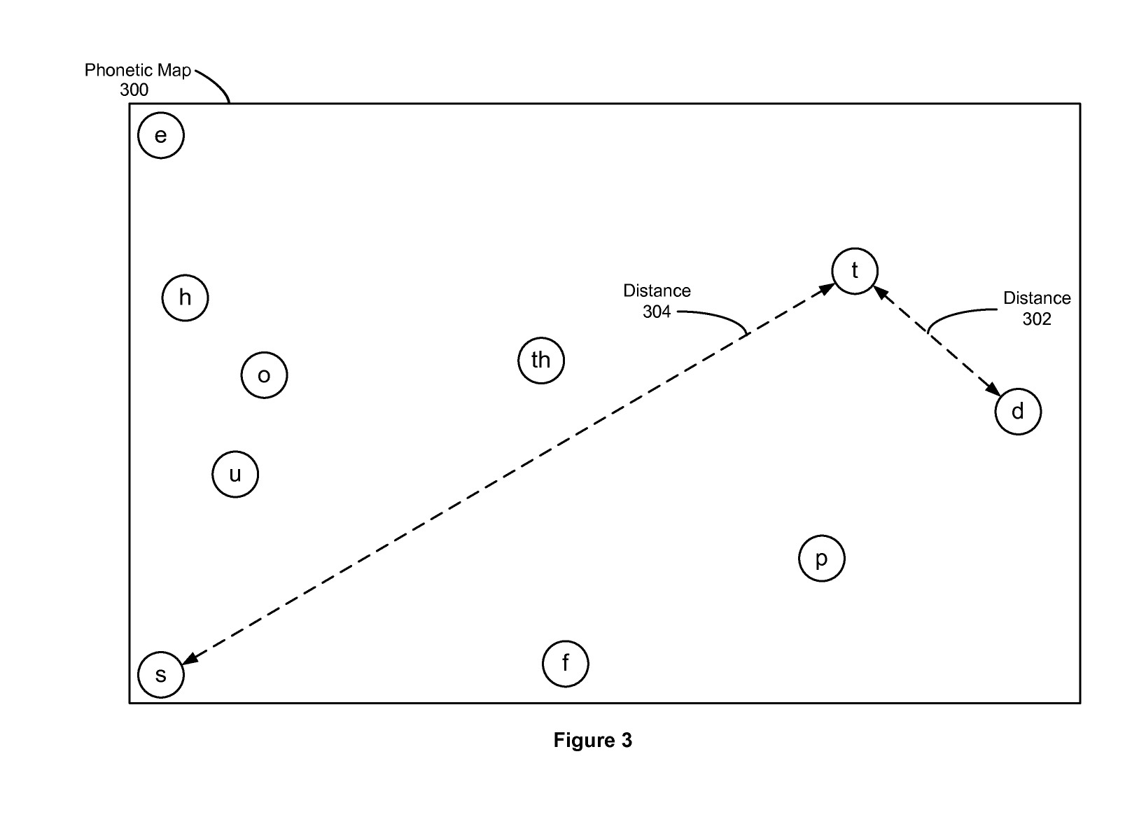

Phonetic map module 234 includes phonetic maps of various alphabets. Phonetic maps 235, described in detail below with reference to FIGS. 3-7, may be provided to transliteration engine 232 to facilitate the transliteration of characters from an input alphabet to an output alphabet. In some embodiments, where the computer system 200 corresponds to a server computer system 104, phonetic maps 235 may be supplied to a transliteration engine resident on a client computer 102, or to a transliteration engine resident on the server computer system 104. In some embodiments, phonetic map module 234 combines single-alphabet phonetic maps to generate combined phonetic maps. In some embodiments, phonetic map module 234 provides single-alphabet phonetic maps to the transliteration engine 232, which in turn generates combined phonetic maps.

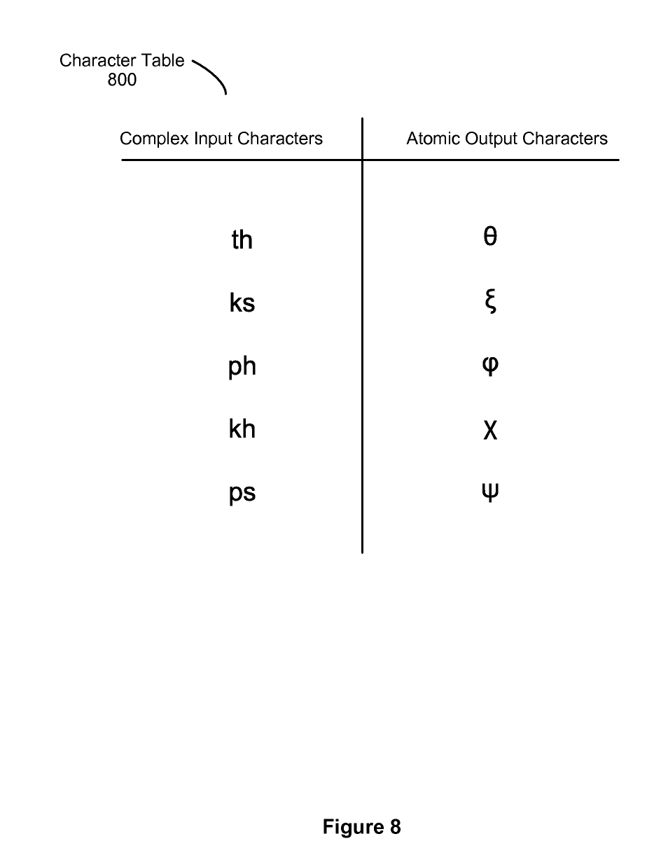

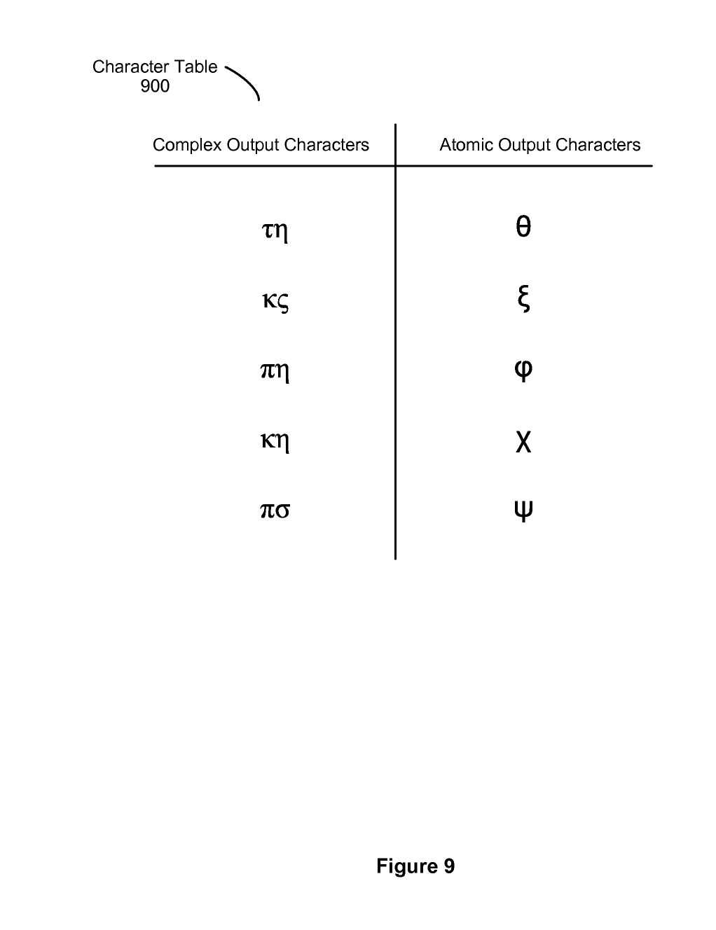

Character table module 236 includes character tables 237 that correlate characters according to their phonetic sounds. Unlike the phonetic maps described herein, the character tables 237 (e.g., character table 800 and 900, described in reference to FIGS. 8-9) include discrete character correlations, where predetermined atomic characters are correlated with predetermined complex characters. In some embodiments, character tables 237 are used to correlate complex characters (e.g., a group of more than one character in a respective language that represents a particular phonetic sound) to atomic characters (e.g., single characters of an alphabet), and vice versa. For example, a character table may correlate the complex Latin character “th” to the atomic Greek character “θ.” In some embodiments, character tables 237 correlate complex characters in a first alphabet to atomic characters in a second alphabet, as described in the preceding example. However, in some embodiments, character tables 237 correlate complex characters to atomic characters within a single alphabet. For example, a character table may correlate the complex Greek character “τη” to the atomic Greek character “θ.”

Word selection module 238 identifies candidate output words based on the characters input by a user. While transliteration engine 232 converts characters from an input alphabet to an output alphabet, the transliteration may not always be entirely accurate, or may not result in a known word in the intended language. That is, the character-wise transliteration from an input alphabet to an output alphabet may not result in a single, exact match to an actual word in the intended language. It may therefore be necessary to further process transliterated character sequences to determine what word the user intended to input. In some embodiments, word selection module 238 works in conjunction with transliteration engine 232 and dictionaries 240 to perform this function.

In some embodiments, word selection module 238 receives, from transliteration engine 232, a sequence of characters in an output alphabet, where the sequence represents a complete word. The word selection module 238 then selects one or more candidate words in the user's intended language that are likely to correspond to the received sequence of characters (e.g., the complete word).

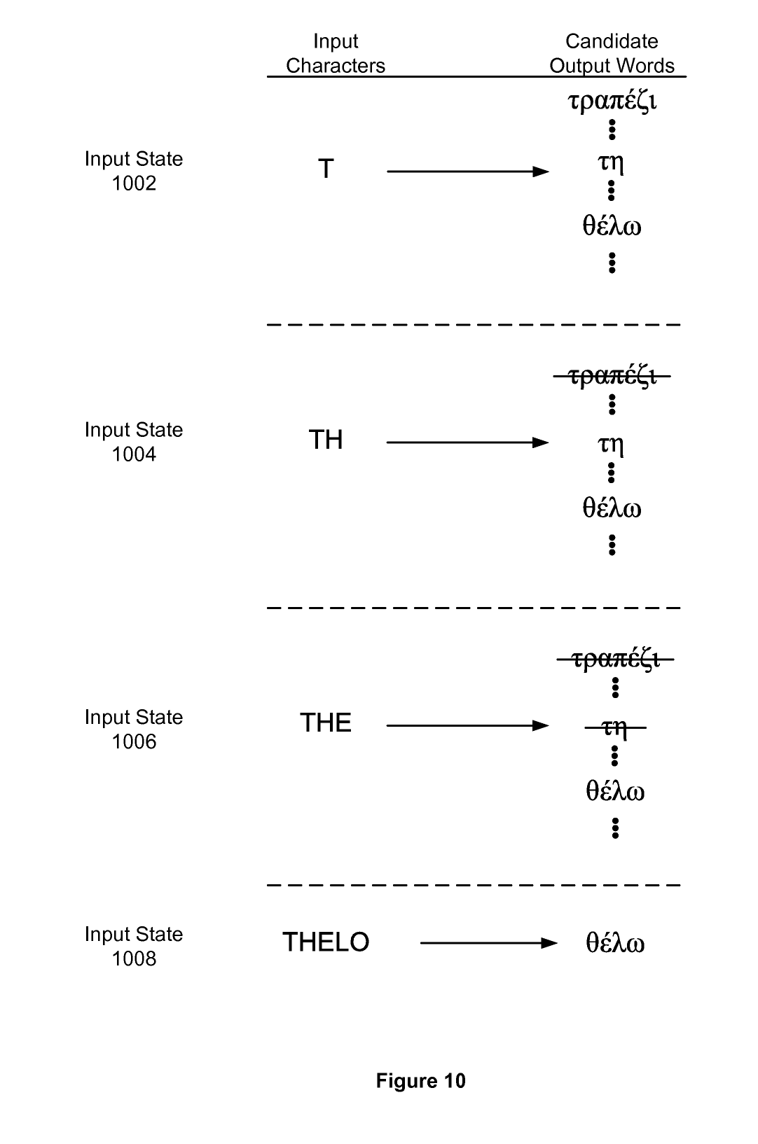

In some embodiments, the word selection module receives, from the transliteration engine 232, a single character, or a sequence of characters that represents less than a complete word. As single characters are received, word selection module 238 may search dictionaries 240 to identify a group of candidate words that might correspond to those individual characters (e.g., that begin with those individual characters). As subsequent characters are received, word selection module 238 updates and/or iterates the group of candidate words based on the new character. Word selection is described in greater detail below with respect to FIG. 10.

Dictionaries 240 contain word lists for various languages. In some embodiments, dictionaries 240 include word lists for only a single language, such as a user-selected language or an automatically identified language. In some embodiments, the single language corresponds to a device-level language selection. In some embodiments, the single language corresponds to an application-level or session-level language selection. In some embodiments, dictionaries 240 include word lists for a plurality languages.

In some embodiments, where the computer system 200 is a client device such as a smartphone, word lists for additional languages may be downloaded to the dictionaries 240 when they are required or requested. In some embodiments, a server computer system 104 stores word lists for a plurality of languages, which can then be sent to client computers 102 when they are needed.

Each of the above identified modules and applications correspond to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules may be combined or otherwise re-arranged in various embodiments. In some embodiments, memory 202 may store a subset of the modules and data structures identified above. Furthermore, memory 202 may store additional modules and data structures not described above. Moreover, the above identified modules and applications may be distributed among multiple computer systems, including client computer systems 102 and server computer systems 104. Data and functions may be distributed among the clients and servers in various ways depending on considerations such as processing speed, communication speed and/or bandwidth, data storage space, etc.

Attention is now turned to phonetic maps. As noted above, phonetic maps according to the present disclosure include each character of a respective alphabet, and the characters are located within the phonetic map according to their phonetic similarity. Specifically, characters associated with similar phonetic sounds are located closer together, and characters associated with dissimilar phonetic sounds are located further apart. Accordingly, the distance between two characters on a phonetic map is inversely proportional to the similarity of the phonetic sounds associated with those characters.

Also, phonetic maps 235 for use with a transliteration engine 232 as described herein all use a common phonetic space, such that characters in different alphabets that have similar sounds are located in similar places in their respective maps. Thus, if a character of an input alphabet has the same phonetic sound of a character in an output alphabet, those characters would be located in the same area (e.g., at the same or similar coordinates) in their respective maps. For example, if the “t” in the Latin alphabet is pronounced like the “τ” in the Greek alphabet, those letters would be in the same area in their respective phonetic maps.

In some embodiments, phonetic maps 235 comprise characters located within a coordinate space (also referred to as a phonetic space). In some embodiments, characters are located in an n-dimensional coordinate space, where each character is associated with a particular location within the coordinate space. In some embodiments, phonetic maps 235 have two dimensions. In some embodiments, phonetic maps 235 have three dimensions. In some embodiments, phonetic maps have four, five, or more dimensions. The location of a character within a phonetic map 235 may be represented by coordinates. The number of coordinates used to represent a character's location in a phonetic map is determined by the number of dimensions of the coordinate space of the phonetic map. For example, characters in a 3-dimensional coordinate space (phonetic space) may be associated with a location defined by coordinate triples.

In some embodiments, the dimensions of a coordinate space each represent a certain phonetic characteristic. For example, in some embodiments, a coordinate space includes dimensions for the manner of phonetic production (i.e., stop, fricative, affricate, nasal, liquid, and glide), the articulators used for phonetic production (i.e., bilabial, labio-dental, lingua-dental, lingua-alveolar, lingua-palatal, lingua-velar, and glottal), the vocal component (i.e., voiced and voiceless), the tongue location during vowel pronunciation (e.g., front, central, and back), and/or the number and/or type of vowel sounds produced consecutively (e.g., monopthongs, dipthongs, triphthongs, etc.). More or fewer dimensions may be employed in various embodiments.

In some embodiments, the dimensions of a coordinate space are not defined by any phonetic value or characteristic. Rather, characters may be located in a coordinate space (e.g., a two-dimensional coordinate space), and the locations of the characters may be manually or automatically manipulated so that the distance between any two characters is inversely proportional to the similarity of those characters' respective phonetic sounds.

In some embodiments, the relative similarity of the characters' phonetic sounds is determined by ear. That is, phonetic similarity may be based on a person's perception of the phonetic sounds associated with the characters. In some embodiments, the relative similarity of the characters' phonetic sounds is determined automatically, for example, by speech and/or audio processing methods. A phonetic map is then generated based on the manually or automatically detected similarity of the sounds associated with the characters.

In some embodiments, phonetic maps 235 are represented graphically. However, phonetic maps need not ever be rendered or represented graphically, or even be capable of being rendered graphically. Indeed, in some embodiments, phonetic maps are represented as one or more data sets from which the phonetic similarity of any two given characters can be determined. In some embodiments, the phonetic similarity between characters may be represented by the distance between those characters in the phonetic space. This distance may be referred to as a phonetic distance. In some embodiments, characters are associated with coordinates representing a particular location within the phonetic space, and distances (i.e., phonetic distances) between any respective characters can be determined by determining a mathematical distance between the respective characters.

Notably, by representing all the characters of an alphabet in a single phonetic map as described above, the technique described herein enables a more flexible, less rigid approach to transliteration. Rather than fixed input-to-output character correlation tables, where input characters are directly correlated with certain output characters, phonetic maps 235 as described herein include more information about the phonetic similarities between all of the characters in an alphabet. For example, phonetic maps 235 are able to show that the Latin “t” sounds similar to the Greek “τ,” and also that the Latin “t” sounds somewhat less similar to the Greek “δ.” Moreover, the actual phonetic similarity between characters can be represented as a phonetic distance (e.g., a numerical distance), indicating just how similar an input character is to other output characters. In the above example, the phonetic distance between “t” and “τ” would be less than the phonetic distance between “t” and “δ.” This distance may be used in various ways when determining what output character a user intended to receive based on their choice of input character, as described below.

The above described phonetic maps improve upon simple character correlations in part because the maps contain all (or most) of the characters of the alphabet, such that the phonetic distances between any two characters can be determined. As described below, this allows for more flexible and more accurate transliterations because the correct output character may be identified even where a user chooses a non-standard or atypical input character to represent a particular phoneme.

Moreover, by mapping alphabets to a common phonetic space, the need to make numerous discrete input-to-output alphabet correlation charts for each desired alphabet pair is avoided. Specifically, each alphabet is mapped to a common phonetic space, rather than being mapped to a second alphabet. Thus, once phonetic maps for several individual alphabets are generated, the transliteration engine 232 can transliterate between any combination of the mapped alphabets. And because the phonetic space is generic (i.e., it is not tied to any particular alphabet or language), phonetic maps may be produced by individuals who have no knowledge of other alphabets (though they may need to do so in conjunction with someone knowledgeable about the phonetic space).

In some embodiments, phonetic maps 235 include only atomic characters (i.e., single characters) of a given alphabet. In some embodiments, phonetic maps 235 also include complex characters. Complex characters are combinations of atomic characters that represent other phonemes. In some embodiments, complex characters are used to represent phonemes that are not otherwise represented in a particular alphabet. By including complex characters in the phonetic maps 235, the transliteration engine may be able to identify candidate output-alphabet characters that would commonly be represented by certain complex characters in an input alphabet.

In some embodiments, phonetic maps 235 include the characters of one alphabet or the characters of multiple alphabets. For example, in some embodiments, a phonetic map includes the characters of both an input and an output alphabet. In some embodiments, a phonetic map includes the characters of only a single alphabet. Unless specifically noted otherwise, reference to a phonetic map in the present discussion includes maps containing characters of only one alphabet and maps containing characters of multiple alphabets.

Some alphabets (and/or languages) use diacritics to modify certain characters of an alphabet. In some embodiments, phonetic maps 235 include characters with diacritics. The characters with diacritics are mapped on the phonetic map according to their phonetic sound, as described above. Diacritical characters may be located certain distances (and directions) from their simple character counterparts depending on the phonetic alteration associated with that diacritic. For example, the acute accent “′” in Modern Greek indicates to a reader the stressed vowel of a polysyllabic word, but the phonetic sound associated with that vowel does not change drastically. Thus, the “\acute{ε}” may be located at or near the “ε” on a Modern Greek phonetic map. By contrast, the addition of a “cedilla” to the Portuguese “c” (resulting in “ç”) changes the pronunciation from a /k/ sound to an /s/ sound in some instances. Accordingly, the “ç” would be placed relatively closer to the /s/ sound, and relatively further from the /k/ sound, than the plain character “c.”

In some embodiments, diacritics are inserted in a candidate output word based on a lookup procedure performed after the transliteration of basic characters (e.g., characters without diacritics or other markings). For example, the Latin input characters “thelo” may be directly transliterated to the Greek output characters “θελω.” The transliteration engine may then lookup “θελω” in a Greek dictionary and identify that the most appropriate match includes a diacritic over the “ε.” The transliteration engine may then provide an output of the Greek word “θ\acute{ε}λω.”

FIGS. 3-7 illustrate portions of phonetic maps, in accordance with some embodiments. The phonetic maps shown and described herein are merely exemplary, and do not necessarily represent phonetically accurate mappings of the characters. Moreover, due to size constraints, the distances between respective characters are not necessarily characteristic of the actual phonetic distance between those characters. For simplicity, phonetic maps shown in FIGS. 3-7 show only a subset of the characters of their respective alphabets; as described above, a complete phonetic map would include all (or most) of the characters of its respective alphabet.

FIG. 3 illustrates a phonetic map 300 of a portion of the Latin alphabet, in accordance with some embodiments. Phonetic map 300 illustrates both atomic Latin characters (e.g., “t,” “h,” etc.) as well as complex characters (e.g., “th”). For clarity throughout the figures of phonetic maps, Latin characters are enclosed in circles.

As noted above, the distance between any two characters on a phonetic map is inversely proportional to the similarity of the phonetic sound associated with those characters. For example, the phonetic sound associated with the Latin “t” is more similar to the Latin “d” than the Latin “s.” (Indeed, the /t/ and /d/ sounds are both lingua-alveolar stops, whereas the /s/ sound is a lingua-alveolar fricative.) Accordingly, the distance between the “t” and the “d” (distance 302) on the phonetic map 300 is smaller than the distance between the “t” and the “s” (distance 304).

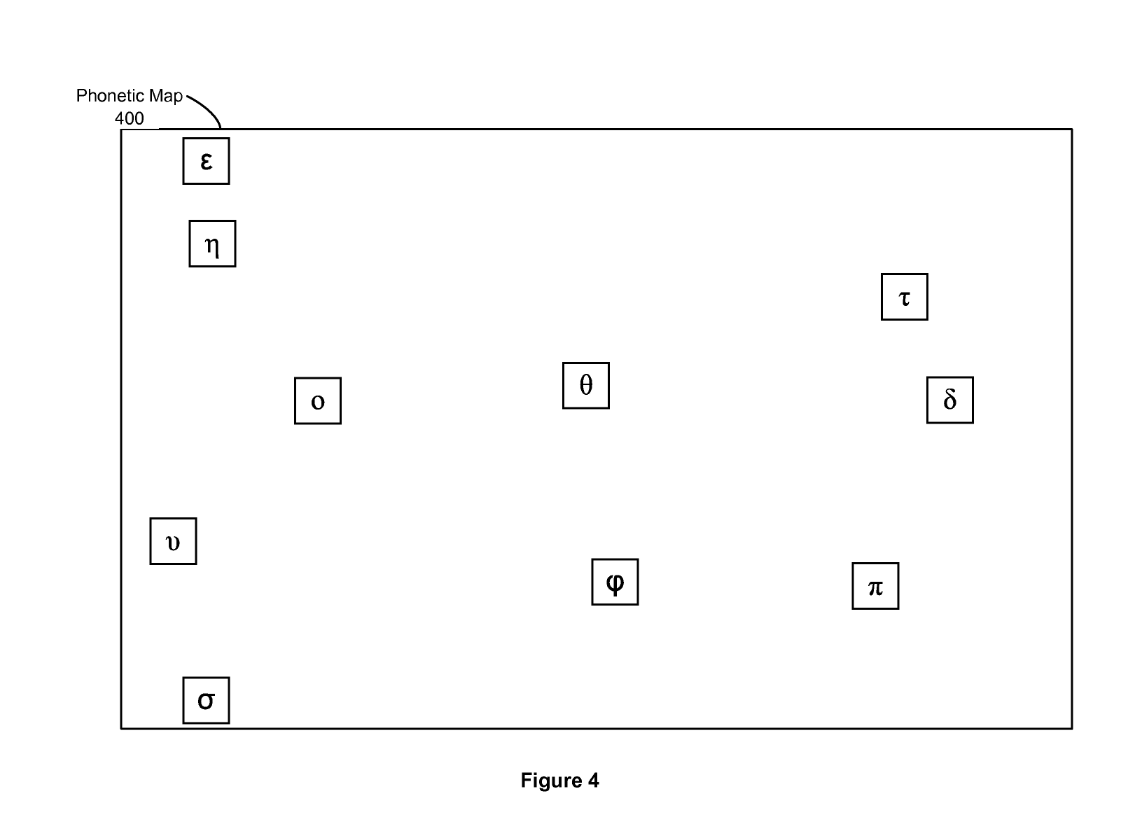

FIG. 4 illustrates a phonetic map 400 of a portion of the Greek alphabet, in accordance with some embodiments. The Greek characters in phonetic map 400 are mapped such that the distance between any two characters is inversely proportional to the similarity of the phonetic sound associated with those characters, as described in detail above. For clarity throughout the figures of phonetic maps, Greek characters are enclosed in squares.

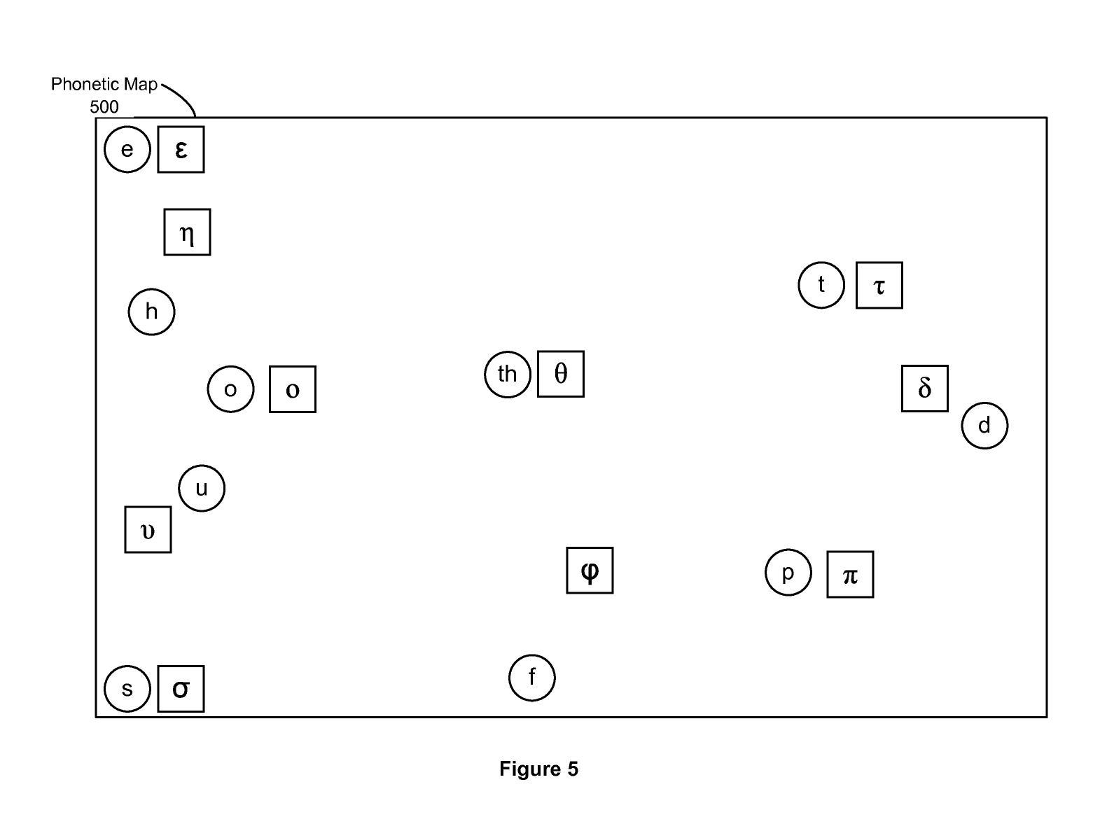

FIG. 5 illustrates a phonetic map 500 that includes a portion of the Latin alphabet and the Greek alphabet. In some embodiments, phonetic map 500 is created and stored (e.g., in the phonetic map module 234) as a combined phonetic map. In some embodiments, phonetic map 500 is generated by overlaying phonetic map 300 over phonetic map 400, or vice versa. In some embodiments, combined phonetic maps are generated in real-time (e.g., by overlaying individual phonetic maps) in response to a specific user request to transliterate between certain alphabets.

As shown in FIG. 5, similar sounding characters are located at similar locations on the phonetic map 500. For example, because the “t” in the Latin alphabet is pronounced like the “τ” in the Greek alphabet, those letters are located at substantially the same or similar location within the phonetic map 500. Because the Greek and Latin alphabets have a relatively similar character set, and represent relatively similar phonemes, many of the characters appear to correspond closely to a single other character. Other combined phonetic maps (e.g., between the Latin alphabet and the Devanagari script) may exhibit substantially less correlation between respective characters.

In combined phonetic maps, such as phonetic map 500, characters that represent the exact same phonetic sound would likely have the same locations within the phonetic space, and would therefore overlap one another when represented graphically. However, for clarity, characters are not shown as overlapping the phonetic maps illustrated herein, even though they may, in fact, have the same location.

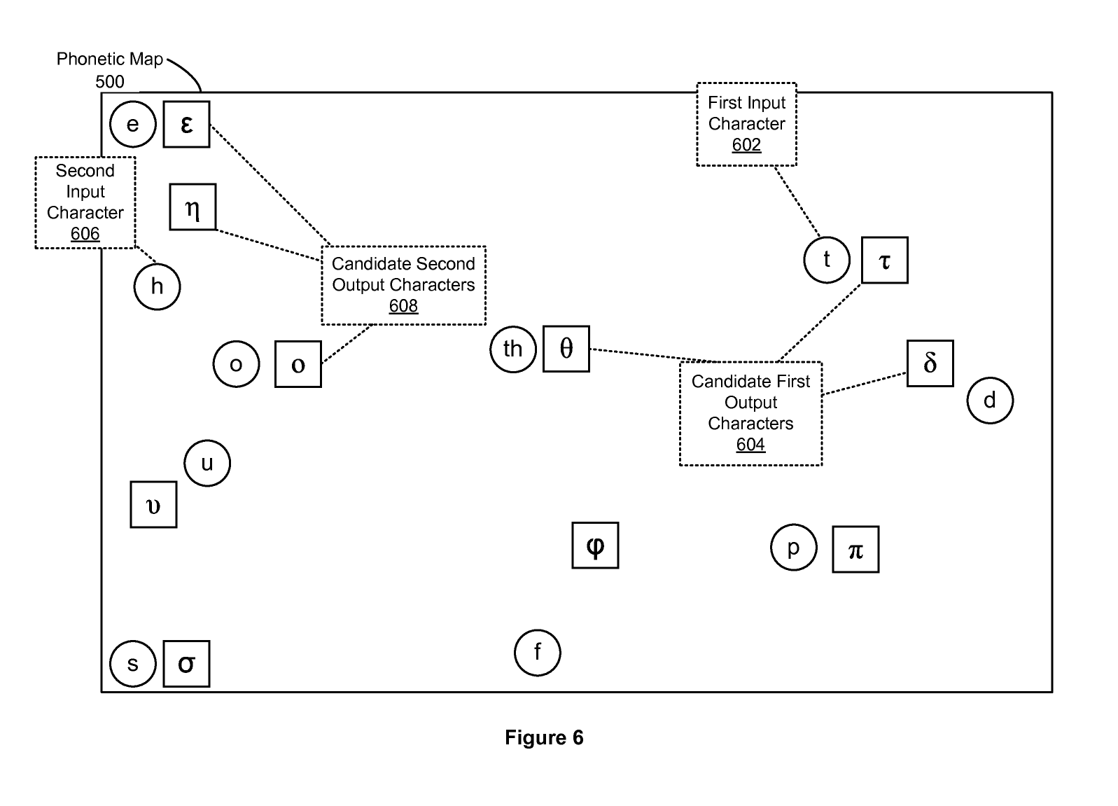

FIG. 6 illustrates phonetic map 500, in accordance with some embodiments. FIG. 6 shows how phonetic maps may be used to identify candidate atomic output characters when atomic input characters are received from a user. The process of identifying output characters is part of the functionality of the transliteration engine 232, and part of the overall transliteration method described herein. FIG. 6 represents a case where a user is inputting Greek words into computer system 200, and has selected Latin as the input alphabet and Greek as the output alphabet. In this example, the user is entering the Latin characters “thelo,” and expects the computer system 200 to output the Greek word “θ\acute{ε}λω.” When the user enters a first input character 602 (a Latin “t”) the transliteration engine 232 will identify one or more candidate first output characters 604. As shown, the candidate first output characters 604 include the Greek “τ,” “δ,” and “θ.” Candidate first output characters 604 (or any candidate output character) may be identified in various different ways. For example, in some embodiments, only the closest output character is selected as a candidate output character. In some embodiments, only the closest “n” output characters are selected as candidate output characters. In some embodiments, all of the output characters within a predetermined distance from the input character are selected as candidate output characters.

In some embodiments, coordinates in a phonetic map represent certain phonetic characteristics, such as the manner of making a particular sound, or whether the sound is voiced or voiceless (i.e., whether the vocal cords are used to produce the sound). And because phonetic maps use coordinate spaces, vectors may be used to represent the relative orientations of respective characters. Accordingly, a vector may include a distance component (e.g., phonetic distance) as well as a direction component (e.g., phonetic direction). Where phonetic direction information is incorporated in phonetic maps, candidate output characters may be determined based on phonetic direction as well as phonetic distance. For example, in some embodiments, only the closest output character in a certain direction on the phonetic map is selected as a candidate output character. In some embodiments, only the closest “n” output characters in a certain direction are selected as candidate output characters. In some embodiments, all of the output characters within a predetermined distance from the input character in a certain direction are selected as candidate output characters.

Moving to the second character in the word, the user inputs a second input character 606 (a Latin “h”). The transliteration engine 232 will then identify one or more candidate second output characters 608, including the Greek “η,” “ε,” and “ο.” After receiving additional input characters and identifying additional candidate output characters, the transliteration engine 232 (sometimes in conjunction with the word selection module 238) will determine a Greek word that the user intended to represent with the particular sequence of input characters. The remaining characters may be transliterated similarly until all candidate output characters are identified for each input character.

The examples of specific inputs and outputs into a transliteration system (including the description of what output characters would be selected for a given input character) are merely illustrative. Specific instances of transliteration engines as described may identify or select different output characters than described, and may arrive at the selection in a different manner than described.

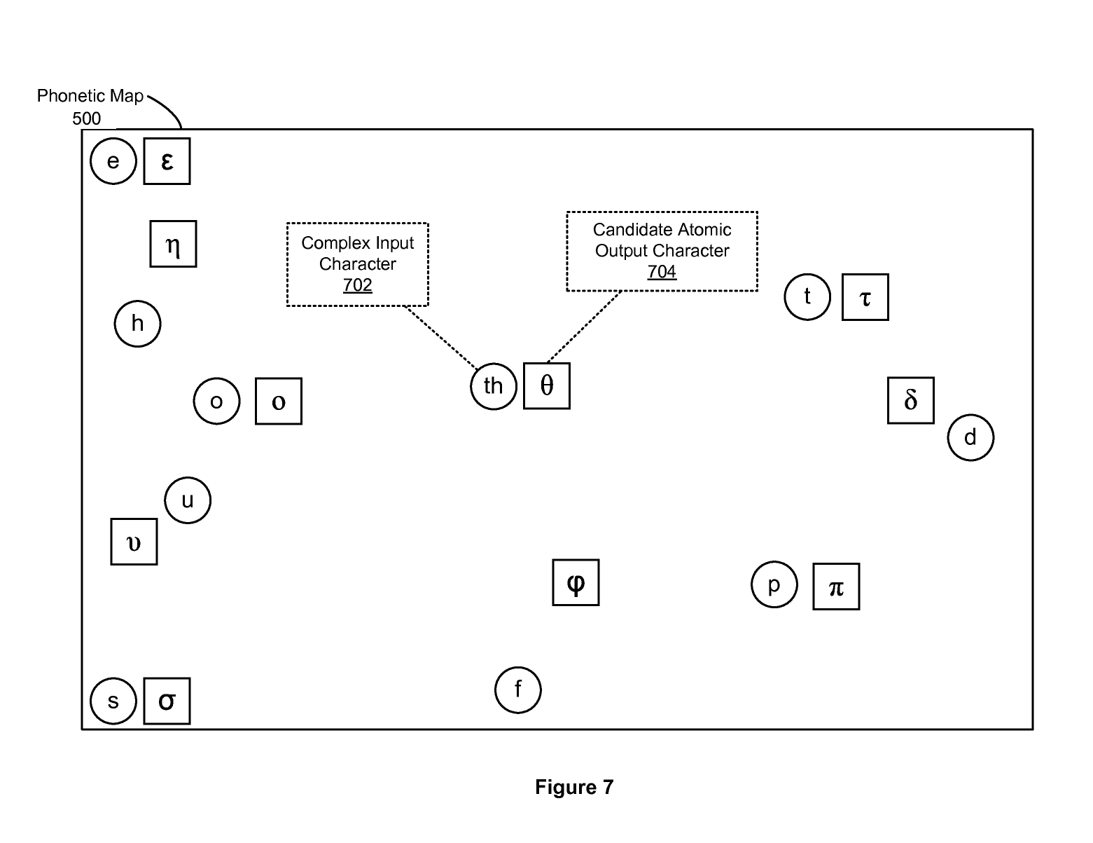

FIG. 7 illustrates phonetic map 500, in accordance with some embodiments. FIG. 7 shows how candidate output characters may be identified when complex characters are involved. FIG. 7 also represents a case where a user is inputting Greek words into a computer system 200, and has selected a Latin input alphabet and a Greek output alphabet. Continuing the example from above, the user is entering the Latin characters “thelo,” and expects the computer system 200 to output the Greek word “θ\acute{ε}λω.” When the user enters a complex input character 702 (e.g., the Latin “th”), the transliteration engine 232 will identify a candidate output character 704. In FIG. 7, the Greek “θ” has been identified as a candidate output character. In some embodiments, the transliteration engine 232 is programmed to recognize certain complex input characters and separately search for candidate output characters for those complex input characters. In some embodiments, the transliteration engine 232 identifies candidate output characters for complex input characters (as described with reference to FIG. 7), while also identifying candidate output characters for the individual characters within that complex input character (as described with reference to FIG. 6). The transliteration engine 232 may then determine whether the user intended the sequence of characters to represent discrete output characters, or a single output character (e.g., whether the user intended “th” to correspond to “τη,” or to “θ.”)

The above example describes how a complex input character may be transliterated to an atomic output character. However, the example applies equally in the reverse situation as well, such as where an atomic input character (e.g., “θ”) is transliterated to a complex output character (e.g., “th”).

In some embodiments, phonetic maps 235 only include atomic characters. Accordingly, when these types of phonetic maps are used the transliteration engine 232 will only identify atomic output characters, even where a complex input character were used to represent a single atomic output character. For example, because the Latin alphabet has no atomic character corresponding to the Greek “θ” (corresponding to the /th/ sound), the user would likely represent that character with the Latin “th.” Where phonetic maps 235 with only atomic characters are used, the maps are only able to transliterate discrete input characters to discrete output characters. Transliteration from atomic input characters to complex output characters, and vice versa, would not be accomplished with those maps alone. Continuing the example from above, transliterating individual characters with such phonetic maps would result in the incorrect transliteration of “thelo” to “τη\acute{ε}λω,” rather than the correct “θ\acute{ε}λω.”

In some embodiments, in order to improve transliteration results, the transliteration engine 232 (and/or the character table module 236) use character tables 237 to identify complex characters that may be more appropriately represented as atomic characters (and vice versa). Character tables 237 may be used in embodiments where phonetic maps 235 only include atomic characters, as described above. FIGS. 8-9 illustrate several examples of character tables 237.

FIG. 8 illustrates a character table 800, in accordance with some embodiments. Character table 800 correlates complex characters in an input alphabet (Latin) to atomic characters in an output alphabet (Greek). When input characters are input by a user, the transliteration engine 232 may determine whether the user has input a complex input character that appears in the character table 800, for example, by searching the character table 800 for sequences of received input characters. If a sequence of input characters is found in the character table 800, the transliteration engine 232 may identify the corresponding individual output character, from the character table 800, as a candidate output character for that complex input character. For example, if a user enters the Latin “ph,” the transliteration engine 232 may find that, in character table 800, the complex input character “ph” corresponds to the Greek “φ,” and may thus identify that character as a candidate output character.

The above example describes how character table 800 may be used to transliterate complex input characters to atomic output characters. However, the lookup process described above may be reversed, such that atomic input characters can be transliterated to complex output characters. For example, if a user entered the Greek “θ,” the transliteration engine 232 may consult character table 800 to determine that the appropriate Latin complex character is “TH.” Accordingly, in some embodiments, the correlation between complex characters in one alphabet and atomic characters in a second alphabet may be used for transliterations between those two alphabets regardless of which alphabet is the input alphabet and which is the output alphabet.

FIG. 9 illustrates a character table 900, in accordance with some embodiments. Character table 900 illustrates how complex characters in an output alphabet may be correlated to atomic characters in the same output alphabet (in this case, Greek). Character table 800, as described above, correlates complex characters between an input alphabet and an output alphabet. In contrast, character table 900 correlates complex characters within only the output alphabet. Accordingly, during the process of transliteration, all atomic input characters may first be transliterated to atomic output characters. The replacement of complex characters for atomic characters, then, takes place after all atomic characters have already been converted to the output alphabet.

For example, when a user enters the Latin “PH” (representing an /f/ sound), those characters may first be transliterated into the atomic Greek characters “π” (a likely transliteration for “p”) and “η” (a likely transliteration for “h”). However, the user may have actually intended to represent the Greek “φ.” Thus, in embodiments where character table 900 is used, the transliteration engine 232 may transliterate each input character to an atomic output character, and then search within the table for the complex Greek character of “πη” in order to identify the Greek “φ” as a candidate output character.

Character tables 237 (including character table 800 and 900) may be used in conjunction with the phonetic maps 235 in various ways and combinations. For example, in embodiments where phonetic maps 235 include only atomic characters, character tables 237 may be used to identify instances where certain character combinations should be represented as an atomic character (or vice versa). However, in some embodiments, character tables 237 may be used to confirm complex-to-atomic transliterations that were generated by the transliteration engine. For example, where phonetic maps 235 include both atomic and complex characters, the transliteration engine 232 may identify that, based on the phonetic maps, a certain input complex character should be represented as an atomic output character. In some embodiments, the transliteration engine may then consult with a list of known or typical complex-to-atomic transliterations (such as character tables 800 and 900) to confirm whether the initial transliteration result appears in the character table. Where the initial transliteration is found in the character table, the initial result is confirmed. On the other hand, if the initial transliteration is not found in the character table, the initial transliteration may be identified as incorrect or a confidence value in the transliteration result may be changed.

In order to ensure quality transliterations, the transliteration systems and methods described herein may include word selection features to help identify the actual words that the user intended to input. In some cases, word selection functions (such as dictionary lookup and/or “autocorrect” style functions) are used to disambiguate transliterations where multiple possible transliteration solutions exist. In some embodiments, such word selection functions are implemented by a word selection module 238 in conjunction with dictionaries 240 (FIG. 2).

FIG. 10 illustrates how word selection module 238, in conjunction with dictionaries 240, may identify an actual word from a set of input characters, in accordance with some embodiments. At input state 1002, the input character “t” has been received. As described above, transliteration engine 232 may use phonetic maps 235 to determine that the Latin “t” may correspond to the Greek “τ” or “θ.” Accordingly, the word selection module 238 may identify candidate output words that begin with either “τ” or “θ.”

At input state 1004, the input character “H” has been received, so that the current input characters are “th.” As described above, this character string may be transliterated to “τη” or to “θ.” The word selection module 238 may then identify candidate output words that begin with either “τη” or “θ,” as these words are consistent with the transliterated input characters. However, words that are inconsistent with the transliterated input characters are removed from the candidate output words. As shown in FIG. 10, the receipt of the second character removed a previously identified candidate output word from the list.

At input state 1006, the input character “e” has been received, so that the current input characters are “the.” As shown in FIG. 10, Greek word “τη” has been removed from the list because it is inconsistent with the transliterated input characters. However, words that are consistent with the current input string remain, including the word “θ\acute{ε}λω.”

Finally, at input state 1008, the complete input character string of “thelo has been received. (In some embodiments, an input character string is determined to be complete when the user inputs a space character or a punctuation mark such as a period, end quote, parenthesis, comma, colon, semicolon, slash, hyphen, exclamation mark, question mark, etc.) As shown in FIG. 10, the list of candidate output words has been narrowed to a single candidate word “θ\acute{ε}λω.”

The word lookup routine performed by the word selection module 238 may also leverage information from the transliteration engine 232 about the phonetic distances between input characters and their respective output characters. Using phonetic distances, the transliteration engine 232 may identify a number of potential output character candidates for a given input character. For example, the transliteration engine 232 may identify as candidate output characters every character that is within a predetermined phonetic distance from an input character on a phonetic map. In some embodiments, where multiple candidate output characters exist for a single input character, all combinations of those candidate output characters are processed by word selection module 238 as described above. For example, a first input character “t” may be near both “τ” and “δ,” and a second input character “ο” may be near both “ο” (omicron) and “υ.” Accordingly, the word selection module may identify candidate output words beginning with all possible combinations of these characters: “το,” “τυ,” “δο,” and “δυ.” Once it becomes apparent that a certain combination of characters does not correspond to any candidate output words (e.g., there is no word in the dictionary beginning with that particular combination of characters), the word selection routine will stop processing that particular characters string.

As noted above, the word selection module 238 may process every possible combination of candidate output characters to determine the output word that the candidate most likely intended. In some embodiments, only one candidate output word will be identified. However, sometimes multiple candidate output words will be identified. In instances where only one candidate output word is identified, that output word may be provided to a user as the final transliteration result. However, when multiple candidate output words are identified, it is necessary to identify a best candidate output word from among the various candidates. In some embodiments, the best candidate output word is the word with a smallest overall phonetic distance between the characters of the candidate output word and the input characters. In some embodiments, the overall phonetic distance of an output word is the sum of the phonetic distances (on a phonetic map) between each input character and its corresponding output character.

In some embodiments, the best candidate output word is the word that has the highest number of individual characters whose phonetic distance from their respective input characters satisfies a predetermined threshold. For example, a five-letter candidate output word may contain four characters that are very close (on a phonetic map) to their respective input characters. In some embodiments, this word is preferred over an alternative five-letter word where only two of the characters are determined to be very close (on a phonetic map) to their respective output characters.

In some embodiments, the best candidate output word is identified using a combination of the above described procedures.

Many modern handheld computing devices (such as PDAs, smartphones, and the like) use very small, touchscreen-based keyboards for text input. In many cases, the keys of these keyboards are substantially smaller than the fingertips of the average user. The small form factor of these keyboards makes it difficult for a user to be sure that they are selecting the correct key. In some cases, these devices are able determine if there is uncertainty in the user's key selection. For example, if a user presses the touschscreen near a border between two keys, the device may identify that the user may have intended to select either of the two keys. In some cases, these devices can assign a confidence value to a user's key selection. In some embodiments, the computer system 200 uses key-selection confidence values when transliterating characters between two alphabets. In some embodiments, key-selection confidence values are used by the word selection module 238 to help determine the candidate output words. For example, in some embodiments, the best candidate output word is the word that has the highest key-selection confidence value. In some embodiments, key-selection confidence values are used in conjunction with phonetic distance values as described above.

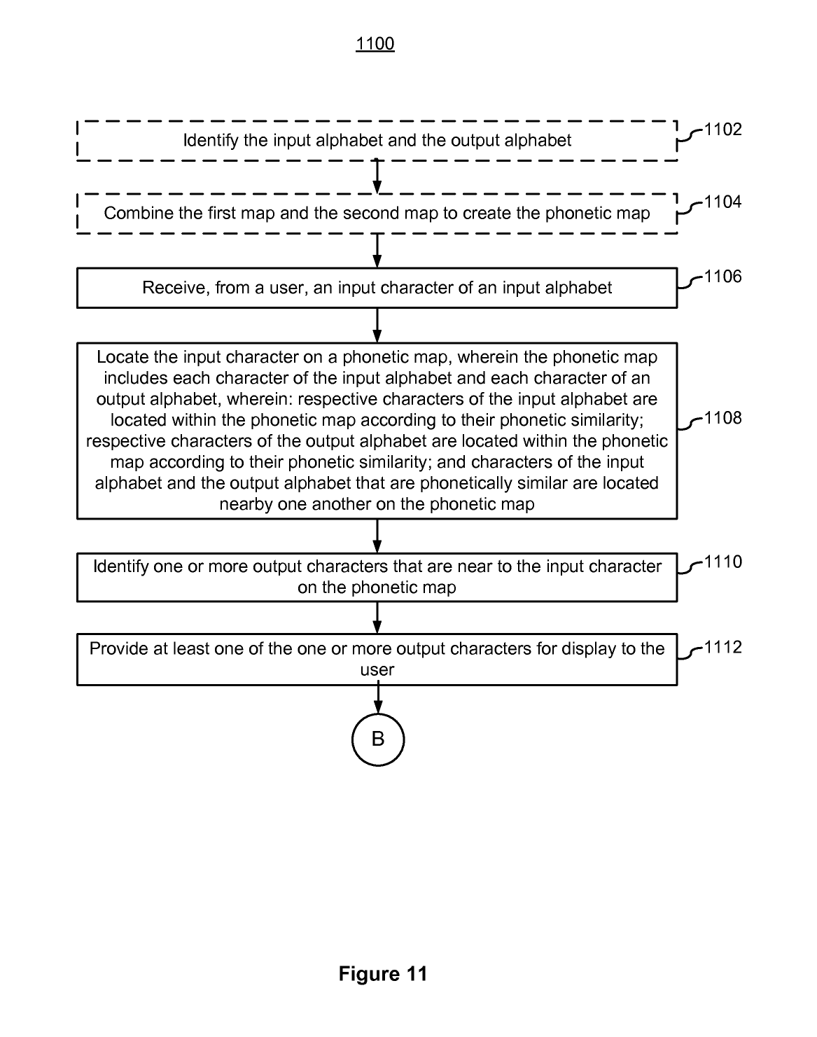

FIGS. 11-14 are flow diagrams illustrating methods for transliterating characters from an input alphabet to an output alphabet in accordance with some embodiments. In some embodiments, the methods are performed at an electronic device (e.g., computer system 200). In some embodiments, the methods are performed by one or more of the modules, programs, or sets of instructions stored in the memory 202 of the computer system 200, including the transliteration engine 232, the phonetic map module 234, the character table module 236, and the word selection module 238.

FIG. 11 is a flow diagram illustrating a method 1100 for transliterating characters from an input alphabet to an output alphabet in accordance with some embodiments. The computer system 200 receives (1106), from a user, an input character of an input alphabet. In some implementations, the input character is input via keyboard 216 or touchscreen 218.

The computer system 200 locates (1108) the input character on a phonetic map. In some embodiments, the phonetic map includes each character of the input alphabet and each character of an output alphabet. Respective characters of the input alphabet are located within the phonetic map according to their phonetic similarity. Also, respective characters of the output alphabet are located within the phonetic map according to their phonetic similarity. Characters of the input alphabet and the output alphabet that are phonetically similar are located nearby one another on the phonetic map. Phonetic maps are described in detail above. In some embodiments, the input characters are located on the phonetic map by the transliteration engine 232.

In some embodiments, the phonetic map is created prior to receiving an input character from the user (e.g., after a user selects an input and output alphabet for transliteration purposes). In some embodiments, the phonetic map is created prior to the deployment of a transliteration system as described herein. In some embodiments, the phonetic map is created manually (e.g., by one or more individuals) and then stored in memory 202 of computer system 200.

In some embodiments, creating the phonetic map includes creating a first map of the input alphabet, wherein the respective characters of the input alphabet are mapped such that the distance between two respective input characters is inversely proportional to the similarity between the two characters' respective phonetic sounds, as described above. In some embodiments, creating the phonetic map further includes creating a second map of the output alphabet, wherein the respective characters of the output alphabet are mapped according to the above described mapping scheme. In some embodiments, the phonetic map is created by combining the first map and the second map. In some embodiments, combining the first map and the second map comprises overlaying the first map and the second map.

In some embodiments, phonetic maps are a set of coordinates that represent locations of individual characters in a phonetic space. Accordingly, in some embodiments, combining phonetic maps comprises combining sets of coordinates of characters of multiple alphabets to generate a combined phonetic map from which phonetic distances can be determined. (For example, by calculating the mathematical distance between characters of an input alphabet and an output alphabet.)

Returning to method 1100, the computer system 200 identifies (1110) one or more output characters that are near to the input character on the phonetic map. In some embodiments, identifying one or more output characters includes identifying a set of candidate output characters based on the phonetic distance between the input character and the one or more output characters on the phonetic map. Various ways of determining output characters are described in greater detail above, and may be used by the computer system 200 in order to identify one or more output characters as described in the present method.

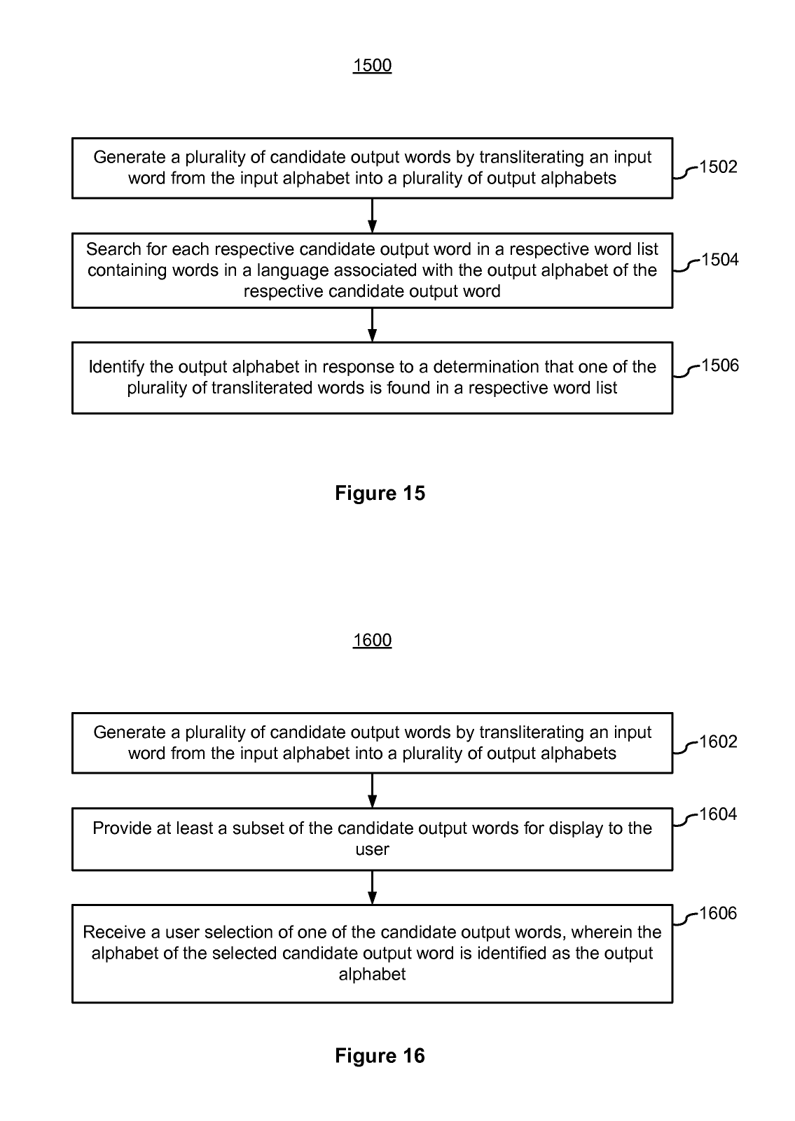

In some embodiments, prior to receiving an input character, computer system 200 identifies (1102) the input alphabet and the output alphabet. In some embodiments, the input alphabet and output alphabet are identified by the language identification module 230 as described above. For example, the input and output alphabets may be selected by a user, or inferred based on information such as the intended output language. A method 1500 of identifying the output alphabet is discussed below with reference to FIG. 15.

In some embodiments, phonetic maps are initially created for individual alphabets, and are not combined until transliteration between two respective alphabets is required by a user. Thus, in some embodiments, after identifying the input alphabet and the output alphabet, the computer system 200 combines (1104) a first map and a second map to create the phonetic map with characters from both the input and output alphabets.

After identifying (1110) one or more output characters, the computer system 200 provides (1112) at least one of the one or more output characters for display to the user. In some embodiments, output characters are provided to the user one at a time, as they are transliterated. In some embodiments, output characters are provided to the user after a plurality of characters (e.g., representing an entire word) are transliterated from the input alphabet to the output alphabet.

In some embodiments, method 1100 uses phonetic maps that include only atomic characters. In these embodiments, method 1100 will identify a single atomic output character for each atomic input character. In some embodiments, method 1100 uses phonetic maps that include complex characters as well as atomic characters. In these embodiments, method 1100 may identify a complex output character (i.e., a combination of several atomic characters) for a given atomic input character. Transliteration between atomic and complex characters (and vice versa) is described in greater detail above with respect to FIGS. 3-9.

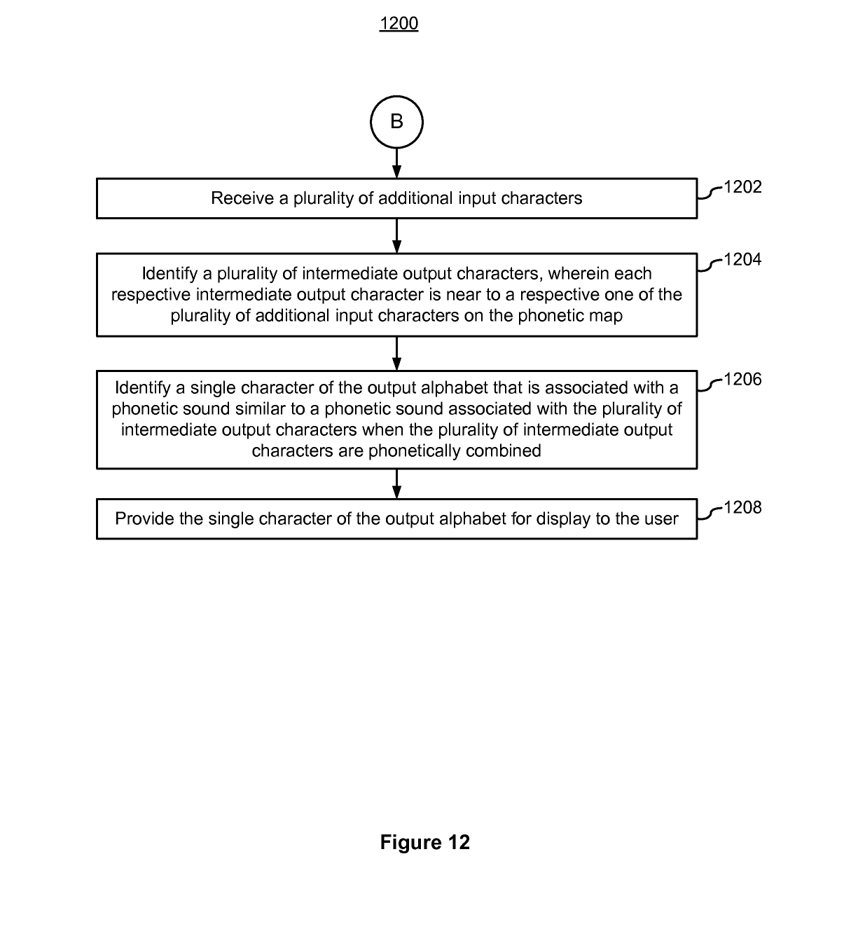

FIG. 12 is a flow diagram illustrating a method 1200 for transliterating characters from an input alphabet to an output alphabet in accordance with some embodiments. In some embodiments, method 1200 is performed in conjunction with other methods described herein. In some embodiments, method 1200 is performed separately from (or without) these methods.

Computer system 200 receives (1202) a plurality of additional input characters. In some embodiments, the plurality of additional input characters corresponds to a complex input-alphabet character that is being used to represent an atomic output-alphabet character, such as where “th” is being used to represent “θ.”

Computer system 200 identifies (1204) a plurality of intermediate output characters, wherein each respective intermediate output character is near to a respective one of the plurality of additional input characters on the phonetic map. Various ways of determining output characters are described above, and may be used by the computer system 200 in order to identify one or more intermediate output characters as described in the present method. In some embodiments, computer system 200 uses phonetic maps to identify intermediate output characters.

Computer system 200 identifies (1206) a single character of the output alphabet that is associated with a phonetic sound similar to a phonetic sound associated with the plurality of intermediate output characters when the plurality of intermediate output characters are phonetically combined.

In some embodiments, the steps of identifying a plurality of intermediate output characters (1204) and then identifying a single character of the output alphabet (1206) may be performed in accordance with the procedure described above with reference to FIG. 9. For example, in some embodiments, the plurality of input characters are converted to a plurality of intermediate output characters using phonetic maps that include only atomic characters of the input and/or output alphabets. The plurality of atomic output characters (which together amount to a complex output character) are then located in a character table to identify (1206) a single character (e.g., atomic character) of the output alphabet.

Computer system 200 provides (1208) the single character of the output alphabet for display to the user. As described above, in some embodiments, output characters are provided to the user one at a time, as they are transliterated. In some embodiments, output characters are provided to the user after a plurality of characters (e.g., representing an entire word) are transliterated from the input alphabet to the output alphabet

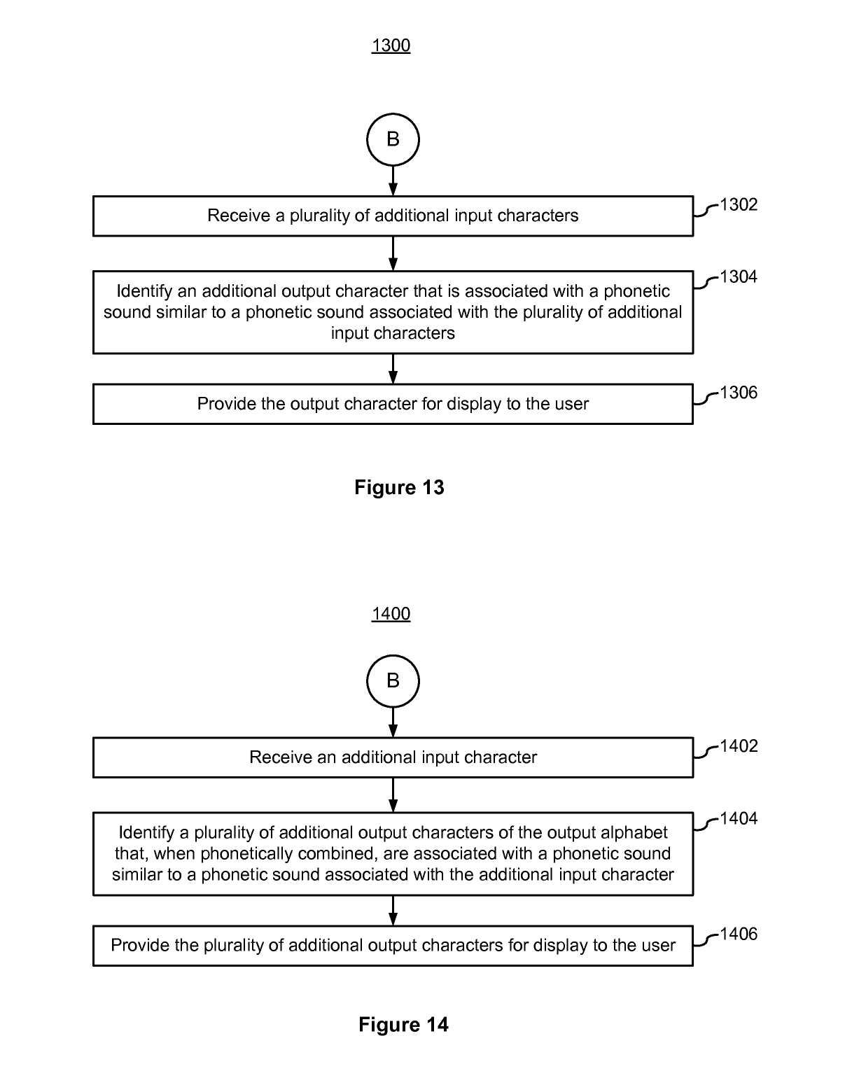

FIG. 13 is a flow diagram illustrating a method 1300 for transliterating characters from an input alphabet to an output alphabet in accordance with some embodiments. In some embodiments, method 1300 is performed in conjunction with other methods described herein. In some embodiments, method 1300 is performed separately from (or without) these methods.

Computer system 200 receives (1302) a plurality of additional input characters. In some embodiments, the plurality of additional input characters corresponds to a complex input-alphabet character that is being used to represent an atomic output-alphabet character, such as where “th” is being used to represent “θ.”

Computer system 200 identifies (1304) an additional output character that is associated with a phonetic sound similar to a phonetic sound associated with the plurality of additional input characters. In some embodiments, the computer system 200 uses character tables 237 to identify an output character at step (1304), as described above with reference to FIG. 8. In some embodiments, the computer system 200 uses phonetic maps that include complex characters as well as atomic characters (e.g., phonetic map 500) to identify an output character at step (1304).

The computer system 200 provides (1306) the additional output character for display to the user. As described above, in some embodiments, output characters are provided to the user one at a time, as they are transliterated. In some embodiments, output characters are provided to the user after a plurality of characters (e.g., representing an entire word) are transliterated from the input alphabet to the output alphabet

FIG. 14 is a flow diagram illustrating a method 1400 for transliterating characters from an input alphabet to an output alphabet in accordance with some embodiments. In some embodiments, method 1400 is performed in conjunction with other methods described herein. In some embodiments, method 1400 is performed separately from (or without) these methods.

The computer system 200 receives (1402) an additional input character. In some embodiments, the additional input character corresponds to an atomic input-alphabet character that is being used to represent a complex output-alphabet character, such as where “θ” is being used to represent “th.”

Computer system 200 identifies (1404) a plurality of additional output characters of the output alphabet that, when phonetically combined, are associated with a phonetic sound similar to a phonetic sound associated with the additional input character. In some embodiments, the computer system 200 uses character tables 237 to identify an output character at step (1404), as described above with reference to FIG. 8.

Computer system 200 provides (1406) the plurality of additional output characters for display to the user. As described above, in some embodiments, output characters are provided to the user one at a time, as they are transliterated. In some embodiments, output characters are provided to the user after a plurality of characters (e.g., representing an entire word) are transliterated from the input alphabet to the output alphabet

FIG. 15 is a flow diagram illustrating a method 1500 for identifying an output alphabet in accordance with some embodiments. In some embodiments, method 1500 is performed in conjunction with other methods described herein. In some embodiments, method 1500 is performed separately from (or without) these methods. In method 1500, computer system 200 transliterates an input word into character strings of several different alphabets, without having previously identified which output alphabet the user is intending to use. In some embodiments, method 1500 is performed by language identification module 230.

Computer system 200 generates (1502) a plurality of candidate output words by transliterating an input word from the input alphabet into a plurality of output alphabets. In some embodiments, the candidate output words are generated by transliterating sequences of characters using methods 1100, 1200, 1300, and/or 1400, as described above.

Computer system 200 searches (1504) for each respective candidate output word in a respective word list containing words in a language associated with the output alphabet of the respective candidate output word. For example, if an input word is transliterated from Latin to Greek and Cyrillic alphabets, computer system 200 may search (1504) for the candidate output word in a Greek word list and a Russian word list.

Computer system 200 identifies (1506) the output alphabet in response to a determination that one of the plurality of transliterated words is found in a respective word list. Continuing the above example, the computer system 200 may find that the candidate output word exists in Greek but not Russian. In this example, then, computer system 200 may identify that the Greek alphabet is the user's desired output alphabet. In some embodiments, once the output alphabet is identified (1506), transliteration continues between the input alphabet and the identified output alphabet without repeating method 1500.

In some embodiments, method 1500 is repeated for each word input by a user. This may be advantageous, for example, if a user wishes to represent words in several output alphabets in a single text input session.

In some cases, a user may wish that certain input words are not transliterated into the identified output alphabet. This may arise if a user wants to input an English word into a Greek text, and desires that the English word should not be transliterated. Accordingly, computer system 200 may be configured to determine an intended output alphabet for each word input by a user. In some embodiments, computer system 200 uses method 1500 for this purpose. In some embodiments, computer system 200 searches for an input word in a word list containing words in a language associated with the input alphabet. Computer system 200 may identify that the input word is itself a candidate output word in response to a determination that the input word is found in the word list of the input alphabet's language.

FIG. 16 is a flow diagram illustrating a method 1600 for identifying an output alphabet in accordance with some embodiments. In some embodiments, method 1600 is performed in conjunction with other methods described herein. In some embodiments, method 1600 is performed separately from (or without) these methods. In method 1600, computer system 200 transliterates an input word into character strings of several different alphabets, without having previously identified which output alphabet the user is intending to use. In some embodiments, method 1600 is performed by language identification module 230.

Computer system 200 generates (1602) a plurality of candidate output words by transliterating an input word from the input alphabet into a plurality of output alphabets. In some embodiments, the candidate output words are generated by transliterating sequences of characters using methods 1100, 1200, 1300, and/or 1400, as described above.

Computer system 200 provides (1604) at least a subset of the candidate output words for display to the user. For example, if an input word is transliterated from Latin into Greek and Cyrillic alphabets, computer system 200 may provide (1504) both the Greek and Cyrillic candidate output words to the user. In some embodiments, the candidate output words do not necessarily exist in the languages associated with the output alphabets, but are merely character-based transliterations of the input word.

Computer system 200 receives (1506) a user selection of one of the candidate output words, wherein the alphabet of the selected candidate output word is identified as the output alphabet. In some embodiments, the candidate output words are selectable by a user, such as by pressing the word on a touchscreen interface.

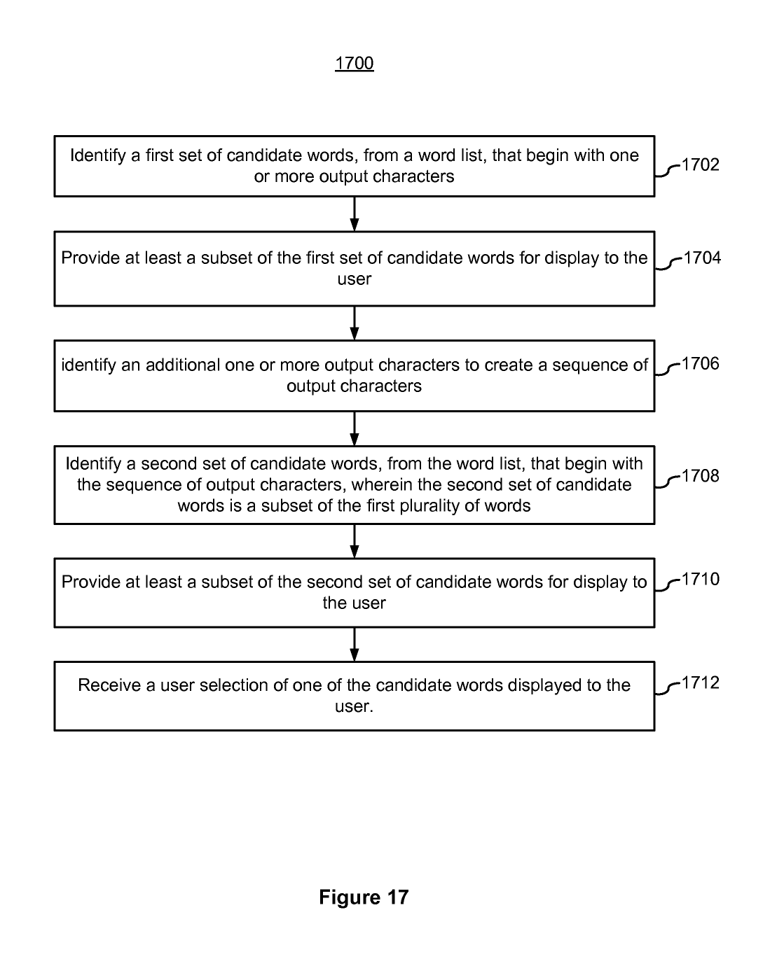

FIG. 17 is a flow diagram illustrating a method 1700 for suggesting words to a user in accordance with some embodiments. In some embodiments, method 1700 is performed in conjunction with other methods described herein. In some embodiments, method 1700 is performed separately from (or without) these methods. In method 1700, candidate complete transliterated words are provided to a user based on the sub-word sequences of characters received from the user. In some embodiments, method 1700 is performed by word selection module 238.

Computer system 200 identifies (1702) a first set of candidate words, from a word list, that begin with one or more output characters. In some embodiments, the one or more output characters are generated by transliterating characters using methods 1100, 1200, 1300, and/or 1400, as described above.

Computer system 200 provides (1704) at least a subset of the first set of candidate words for display to the user. For example, if an input character “t” has been transliterated to the Greek “τ,” the Greek words “τραπ\acute{ε}ζι” and “τη” (among others) may be displayed to a user for selection.

Computer system 200 identifies (1706) an additional one or more output characters to create a sequence of output characters. The additional one or more output characters may correspond to subsequent characters in an input word, and the sequence of output characters may correspond to a word stem in the output alphabet. For example, after inputting “t,” the user may input “h.” Computer system 200 transliterates this additional character to generate the sequence of output characters “τη.” (In some embodiments, computer system 200 also identifies that “τη” corresponds to the atomic output character “θ” and includes this character as a potential initial character of the word suggestion method described herein.) Accordingly, the words “τη” and “θ\acute{ε}λω,” among others, may be displayed to a user for selection.

Computer system identifies (1708) a second set of candidate words, from the word list, that begin with the sequence of output characters, wherein the second set of candidate words is a subset of the first plurality of words.

Computer system provides (1710) at least a subset of the second set of candidate words for display to the user. In some embodiments, at least one of the words provided for display to the user is selected in accordance with a determination that the at least one word has previously been input by the user. In some embodiments, at least one of the words provided for display to the user is selected in accordance with a determination that the at least one word is frequently used in a language associated with the output alphabet.

Computer system 200 receives (1712) a user selection of one of the candidate words displayed to the user. Candidate words may be selectable by a user, such as by pressing the word on a touchscreen interface.

It should be understood that the particular order in which the operations in FIGS. 11-17 have been described is merely exemplary and is not intended to indicate that the described order is the only order in which the operations could be performed. One of ordinary skill in the art would recognize various ways to reorder the operations described herein. Additionally, it should be noted that details of other processes described herein may be applied in addition to, instead of, or in conjunction with the operations described with reference to FIG. 11-17.

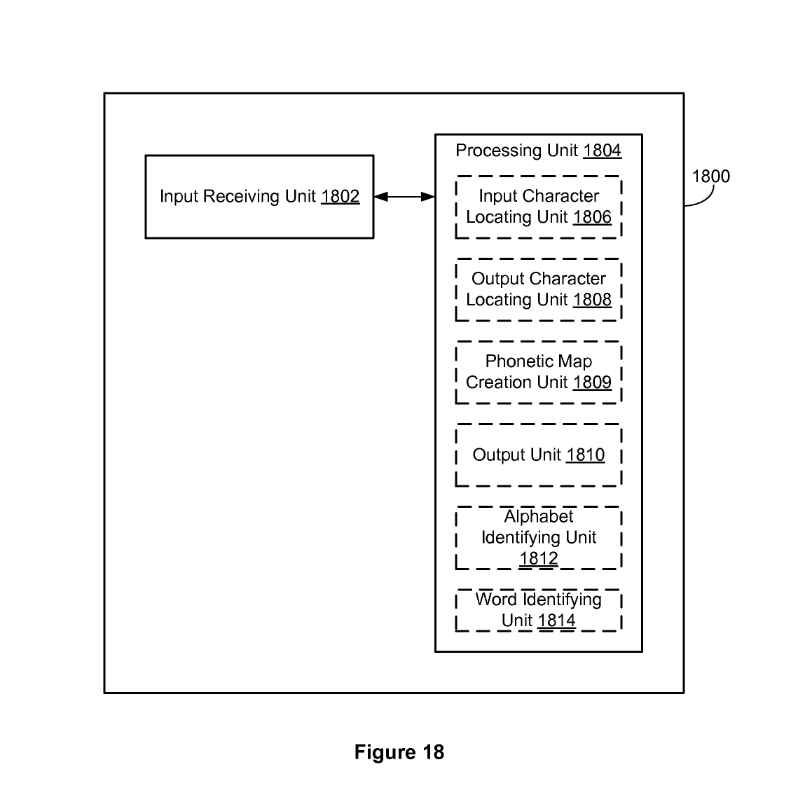

FIG. 18 shows a functional block diagram of an electronic device 1800 configured in accordance with the principles of the invention as described above. The functional blocks of the device may be implemented by hardware, software, or a combination of hardware and software to carry out the principles of the invention. It is understood by persons of skill in the art that the functional blocks described in FIG. 18 may be combined or separated into sub-blocks to implement the principles of the invention as described above. Therefore, the description herein may support any possible combination or separation or further definition of the functional blocks described herein.

As shown in FIG. 18, the electronic device 1800 includes an input receiving unit 1802 configured to receive, from a user, an input character of an input alphabet. The electronic device also includes a processing unit 1804 coupled to the input receiving unit 1802. In some embodiments, the processing unit 1804 includes an input character locating unit 1806, an output character identifying unit 1808, a phonetic map creation unit 1809, an output unit 1810, an alphabet identifying unit 1812, and a word identifying unit 1814.

The processing unit 1804 is configured to locate the input character on a phonetic map, wherein the phonetic map includes each character of the input alphabet and each character of an output alphabet (e.g., with the input character locating unit 1806). In some embodiments, with respect to the phonetic maps, respective characters of the input alphabet are located within the phonetic map according to their phonetic similarity; respective characters of the output alphabet are located within the phonetic map according to their phonetic similarity; and characters of the input alphabet and the output alphabet that are phonetically similar are located nearby one another on the phonetic map. The processing unit 1804 is further configured to identify one or more output characters that are near to the input character on the phonetic map (e.g., with the output character identifying unit 1808); and provide at least one of the one or more output characters for display to the user (e.g., with the output unit 1810).

In some embodiments, the processing unit 1802 is configured to receive a plurality of additional input characters (e.g., with the input receiving unit 1802); identify a plurality of intermediate output characters, wherein each respective intermediate output character is near to a respective one of the plurality of additional input characters on the phonetic map (e.g., with the output character locating unit 1808); identify a single character of the output alphabet that is associated with a phonetic sound similar to a phonetic sound associated with the plurality of intermediate output characters when the plurality of intermediate output characters are phonetically combined (e.g., with the output character locating unit 1808); and provide the single character of the output alphabet for display to the user (e.g., with the output unit 1810).

In some embodiments, the processing unit is configured to receive a plurality of additional input characters (e.g., with the input receiving unit 1802); identify an additional output character that is associated with a phonetic sound similar to a phonetic sound associated with the plurality of additional input characters (e.g., with the output character locating unit 1808); and provide the additional output character for display to the user (e.g., with the output unit 1810). In some embodiments, the phonetic map includes at least one complex character comprising the plurality of additional input characters, and the additional output character is located near the complex character on the phonetic map. In some embodiments, the additional output character is identified using a table that correlates the plurality of additional input characters to one or more atomic output characters.

In some embodiments, the processing unit is configured to receive an additional input character (e.g., with the input receiving unit 1802); identify a plurality of additional output characters of the output alphabet that, when phonetically combined, are associated with a phonetic sound similar to a phonetic sound associated with the additional input character (e.g., with the output character locating unit 1808); and provide the plurality of additional output characters to the user (e.g., with the output unit 1810).

In some embodiments, the processing unit is configured to, prior to receiving the input character, create a first map of the input alphabet (e.g., with the phonetic map creation unit 1809), wherein the respective characters of the input alphabet are mapped such that the distance between two respective input characters is inversely proportional to the similarity between the two characters' respective phonetic sounds; and create a second map of the output alphabet, wherein the respective characters of the output alphabet are mapped such that the distance between two respective output characters is inversely proportional to the similarity between the two output characters' respective phonetic sounds (e.g., with the phonetic map creation unit 1809). In some embodiments, the processing unit is configured to combine the first map and the second map to create the phonetic map (e.g., with the phonetic map creation unit 1809). In some embodiments, the processing unit is configured to combine the first map and the second map by overlaying the first map and the second map (e.g., with the phonetic map creation unit 1809). In some embodiments, the processing unit is configured to combine the first map and the second map prior to receiving the input character (e.g., with the phonetic map creation unit 1809).

In some embodiments, the processing unit is configured to, prior to receiving an input character, identify the input alphabet and the output alphabet (e.g., with the alphabet identifying unit 1812). In some embodiments, the processing unit is configured to combine the first map and the second map after the input alphabet and the output alphabet are identified (e.g., with the phonetic map creation unit 1809). In some embodiments, the processing unit is configured to identify the input alphabet based on an active keyboard of a computer system (e.g., with the alphabet identifying unit 1812).

In some embodiments, the processing unit is configured to automatically identify the output alphabet by generating a plurality of candidate output words by transliterating an input word from the input alphabet into a plurality of output alphabets (e.g., with the input receiving unit 1802 and the processing unit 1804); searching for each respective candidate output word in a respective word list containing words in a language associated with the output alphabet of the respective candidate output word (e.g., with the alphabet identifying unit 1812); and identifying the output alphabet in response to a determination that one of the plurality of transliterated words is found in a respective word list (e.g., with the alphabet identifying unit 1812).

In some embodiments, the processing unit is configured to identify the output alphabet by generating a plurality of candidate output words by transliterating an input word from the input alphabet into a plurality of output alphabets (e.g., with the word identifying unit 1814); providing at least a subset of the candidate output words for display to the user (e.g., with the output unit 1810); and receiving a user selection of one of the candidate output words, wherein the alphabet of the selected candidate output word is identified as the output alphabet (e.g., with the input receiving unit 1802).

In some embodiments, the processing unit is configured to identify a first set of candidate words, from a word list, that begin with the one or more output characters (e.g., with the word identifying unit 1814); provide at least a subset of the first set of candidate words for display to the user (e.g., with the output unit 1810); and receive a user selection of one of the candidate words displayed to the user (e.g., with the input receiving unit 1802).

In some embodiments, the processing unit is configured to identify an additional one or more output characters to create a sequence of output characters (e.g., with the output locating unit 1808); identify a second set of candidate words, from the word list, that begin with the sequence of output characters, wherein the second set of candidate words is a subset of the first plurality of words (e.g., with the word identifying unit 1814); and provide at least a subset of the second set of candidate words for display to the user (e.g., with the output unit 1810).

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for transliterating characters from an input alphabet to an output alphabet, comprising:
at an electronic device with a processor and memory storing instructions for execution by the processor:
receiving, from a user, an input character of an input alphabet;
locating the input character on a phonetic map, wherein the phonetic map includes each character of the input alphabet and each character of an output alphabet, wherein: respective characters of the input alphabet are located within the phonetic map according to their phonetic similarity; respective characters of the output alphabet are located within the phonetic map according to their phonetic similarity; and characters of the input alphabet and the output alphabet that are phonetically similar are located nearby one another on the phonetic map;
identifying one or more output characters that are near to the input character on the phonetic map; and
providing at least one of the one or more output characters for display to the user.

2. The method of claim 1, further comprising:
receiving a plurality of additional input characters;
identifying a plurality of intermediate output characters, wherein each respective intermediate output character is near to a respective one of the plurality of additional input characters on the phonetic map;
identifying a single character of the output alphabet that is associated with a phonetic sound similar to a phonetic sound associated with the plurality of intermediate output characters when the plurality of intermediate output characters are phonetically combined; and
providing the single character of the output alphabet for display to the user.

3. The method of claim 1, further comprising:
receiving a plurality of additional input characters;
identifying an additional output character that is associated with a phonetic sound similar to a phonetic sound associated with the plurality of additional input characters; and
providing the additional output character for display to the user.

4. The method of claim 3, wherein the phonetic map includes at least one complex character comprising the plurality of additional input characters, and the additional output character is located near the complex character on the phonetic map.

5. The method of claim 3, wherein the additional output character is identified using a table that correlates the plurality of additional input characters to one or more atomic output characters.

6. The method of claim 1, further comprising:
receiving an additional input character;
identifying a plurality of additional output characters of the output alphabet that, when phonetically combined, are associated with a phonetic sound similar to a phonetic sound associated with the additional input character; and
providing the plurality of additional output characters to the user.

7. The method of claim 1, further comprising:
prior to receiving the input character:
creating a first map of the input alphabet, wherein the respective characters of the input alphabet are mapped such that the distance between two respective input characters is inversely proportional to the similarity between the two characters' respective phonetic sounds; and
creating a second map of the output alphabet, wherein the respective characters of the output alphabet are mapped such that the distance between two respective output characters is inversely proportional to the similarity between the two output characters' respective phonetic sounds.

8. The method of claim 7, further comprising combining the first map and the second map to create the phonetic map.

9. The method of claim 8, wherein combining the first map and the second map comprises overlaying the first map and the second map.

10. The method of claim 8, wherein the first map and the second map are combined prior to receiving the input character.

11. The method of claim 1, further comprising:
prior to receiving an input character, identifying the input alphabet and the output alphabet.

12. The method of claim 11, wherein the first map and the second map are combined after the input alphabet and the output alphabet are identified.

13. The method of claim 11, wherein the input alphabet is identified based on an active keyboard of a computer system.

14. The method of claim 1, further comprising:
automatically identifying the output alphabet by:
generating a plurality of candidate output words by transliterating an input word from the input alphabet into a plurality of output alphabets;
searching for each respective candidate output word in a respective word list containing words in a language associated with the output alphabet of the respective candidate output word; and
identifying the output alphabet in response to a determination that one of the plurality of transliterated words is found in a respective word list.

15. The method of claim 1, further comprising:
identifying the output alphabet by:
generating a plurality of candidate output words by transliterating an input word from the input alphabet into a plurality of output alphabets;
providing at least a subset of the candidate output words for display to the user; and
receiving a user selection of one of the candidate output words, wherein the alphabet of the selected candidate output word is identified as the output alphabet.

16. The method of claim 1, wherein the phonetic map has at least two dimensions.

17. The method of claim 15, wherein locations on the phonetic map are specified by coordinates.

18. The method of claim 1, wherein the one or more output characters comprise a plurality of discrete characters of the output alphabet.

19. The method of claim 18, wherein each discrete character of the one or more output characters is associated with a phonetic sound similar to a phonetic sound associated with the input character.

20. The method of claim 1, wherein the one or more output characters comprise a complex character made up of two or more characters of the output alphabet.

21. The method of claim 20, wherein the complex character is associated with a phonetic sound similar to a phonetic sound associated with the input character.

22. The method of claim 1, further comprising:
identifying a first set of candidate words, from a word list, that begin with the one or more output characters;
providing at least a subset of the first set of candidate words for display to the user; and
receiving a user selection of one of the candidate words displayed to the user.

23. The method of claim 22, further comprising:
identifying an additional one or more output characters to create a sequence of output characters;
identifying a second set of candidate words, from the word list, that begin with the sequence of output characters, wherein the second set of candidate words is a subset of the first plurality of words; and
providing at least a subset of the second set of candidate words for display to the user.

24. The method of claim 23, wherein at least one of the words provided for display to the user is selected in accordance with a determination that the at least one word has previously been input by the user.

25. The method of claim 23, wherein at least one of the words provided for display to the user is selected in accordance with a determination that the at least one word is frequently used in a language associated with the output alphabet.

26. An electronic device, comprising:
one or more processors;
memory; and
one or more programs, wherein the one or more programs are stored in the memory and configured to be executed by the one or more processors, the one or more programs including instructions for:
receiving, from a user, an input character of an input alphabet;
locating the input character on a phonetic map, wherein the phonetic map includes each character of the input alphabet and each character of an output alphabet, wherein: respective characters of the input alphabet are located within the phonetic map according to their phonetic similarity; respective characters of the output alphabet are located within the phonetic map according to their phonetic similarity; and characters of the input alphabet and the output alphabet that are phonetically similar are located nearby one another on the phonetic map;
identifying one or more output characters that are near to the input character on the phonetic map; and
providing at least one of the one or more output characters for display to the user.

27. A non-transitory computer readable storage medium storing one or more programs, the one or more programs comprising instructions, which when executed by an electronic device, cause the device to:
receive, from a user, an input character of an input alphabet;
locate the input character on a phonetic map, wherein the phonetic map includes each character of the input alphabet and each character of an output alphabet, wherein: respective characters of the input alphabet are located within the phonetic map according to their phonetic similarity; respective characters of the output alphabet are located within the phonetic map according to their phonetic similarity; and characters of the input alphabet and the output alphabet that are phonetically similar are located nearby one another on the phonetic map;
identify one or more output characters that are near to the input character on the phonetic map; and
provide at least one of the one or more output characters for display to the user.
